(19) United States
(12) Patent Application Publication
(10) Pub. No.: US 2026/0154974 A1
(43) Pub. Date: Jun. 4, 2026

(54) AI ADJUSTED ROI ENCODING FOR IMPROVED LICENSE PLATE TEXT CLARITY IN RECORDED VIDEO

(71) Applicant: Ambarella International LP, Santa Clara, CA (US)

(72) Inventors: Luyi Sun, Shanghai (CN); Han-wen Guo, Shanghai (CN); Sheng Jiang, Shanghai (CN)

(21) Appl. No.: 18/969,927

(22) Filed: Dec. 5, 2024

(30) Foreign Application Priority Data
Nov. 29, 2024 (CN) 202411744984.4

(51) Int. Cl. G06V 20/62; G06T 7/20; G06V 10/25; G06V 10/82; G06V 20/58; H04N 19/167; H04N 19/172; H04N 19/176; H04N 19/70

(52) U.S. Cl. CPC G06V 20/625; G06T 7/20; G06V 10/25; G06V 10/82; G06V 20/582; H04N 19/167; H04N 19/172; H04N 19/176; H04N 19/70

(57) ABSTRACT

An apparatus comprising an interface and a processor. The interface may be configured to receive pixel data. The processor may be configured to process the pixel data arranged as video frames, detect a bounding box location for a vehicle in the video frames, perform license plate detection within the bounding box location to detect a license plate region, determine first encoding parameters, determine second encoding parameters for the license plate region and generate encoded video frames using the first encoding parameters outside of the license plate region and the second encoding parameters within the license plate region. An offset may be applied to the first encoding parameters to determine the second encoding parameters. The second encoding parameters may provide clarity of text while keeping an average bitrate of the encoded video the same as encoding an entire one of the video frames using the first encoding parameters.

This application relates to China Application No. 202411744984.4, filed on Nov. 29, 2024, which is incorporated by reference.

### FIELD OF THE INVENTION

The invention relates to computer vision generally and, more particularly, to a method and/or apparatus for implementing AI adjusted ROI encoding for improved license plate text clarity in recorded video.

### BACKGROUND

Modern cameras are capable of capturing highly detailed images and video. For example, 4K video is capable of providing crisp and vivid details. However, not all camera applications are capable of using high resolution cameras. High resolution cameras are expensive, can result in high processing resource consumption, consume a lot of power, and result in large file sizes. Some camera applications are bandwidth limited. For example, camera systems that communicate encoded video over wireless networks (i.e., 4G/5G/LTE) may have limited bandwidth available to communicate the captured video data compared to hard-wired (i.e., Ethernet connected) camera systems. Encoding and/or compression is implemented to limit a bitrate of output video. However, encoded video has less subjective video quality, and text can become illegible.

Moving cameras, such as vehicle-mounted cameras, provide a particular challenge when encoding at lower bitrates. Moving scenes tend to change continuously, resulting in significant changes to most of the visual content from frame to frame. For example, a video encoded in H.265 to provide 1080p30 video with a constant bitrate of 2 Mbps can be used for a road traffic scene. Conventional video rate control algorithms are region agnostic (i.e., have no preference for video quality in any specific region). The resulting low bitrate video for a scene with lots of moving content can have bit allocation to a small area that is not sufficient to encode the video clearly, resulting in poor text clarity.

Text clarity is important in video. Text provides key information about location (i.e., street signs, building names, addresses). Text clarity is particularly important for vehicle license plates. License plate characters should be recognizable in output video. For example, license plate legibility is important for police and insurance investigations. Video with legible text is preferable and more convincing than text output that has been generated from the video. License plate readers are capable of determining license plate numbers in a text format. Optical character recognition can also extract text from images and video. However, the text is separate from the image/video, and is stored separately (or as metadata). Storing license plate numbers is a privacy issue.

Higher bitrate video (i.e., double or more), with higher resolution of CMOS sensors (i.e., 4K image sensor) is capable of recording a license plate with better text clarity. However, high resolution image sensors are expensive and the resulting file sizes are large.

It would be desirable to implement AI adjusted ROI encoding for improved license plate text clarity in recorded video.

### SUMMARY

The invention concerns an apparatus comprising an interface and a processor. The interface may be configured to receive pixel data. The processor may be configured to process the pixel data arranged as video frames, perform computer vision operations on the video frames in an uncompressed format, detect a bounding box location for a vehicle in response to the computer vision operations, perform license plate detection within the bounding box location to detect a region of interest of a license plate of the vehicle, determine first encoding parameters to generate encoded video frames from the video frames in the uncompressed format, determine second encoding parameters for the region of interest of the license plate and generate the encoded video frames using the first encoding parameters outside of the region of interest and the second encoding parameters within the region of interest. An offset may be applied to the first encoding parameters for the region of interest to determine the second encoding parameters. The second encoding parameters may provide clarity of text of the license plate within the region of interest while keeping an average bitrate of the encoded video the same as encoding an entire one of the video frames using the first encoding parameters.

### BRIEF DESCRIPTION OF THE FIGURES

Embodiments of the invention will be apparent from the following detailed description and the appended claims and drawings.

FIG. 1 is a diagram illustrating examples of cameras that may implement AI adjusted ROI encoding for improved license plate text clarity in recorded video in accordance with example embodiments of the invention.

FIG. 2 is a diagram illustrating example edge device cameras.

FIG. 3 is a diagram illustrating an example embodiment of the present invention configured to provide an all-around view of a vehicle.

FIG. 4 is a block diagram illustrating a camera system.

FIG. 5 is a block diagram illustrating an AI adjusted region of interest encoding pipeline.

FIG. 6 is a diagram illustrating computer vision operations performed on an example video frame to detect vehicle bounding box locations.

FIG. 7 is a diagram illustrating vehicle license plate detection at a block level of a video frame.

FIG. 8 is a diagram illustrating an example encoding parameter offset to apply to a license plate region of interest.

FIG. 9 is a diagram illustrating a portion of an encoded video frame with enhanced text clarity.

FIG. 10 is a diagram illustrating computer vision operations performed on an example video frame to detect road sign locations.

FIG. 11 is a diagram illustrating sign text detection at a block level of a video frame.

FIG. 12 is a flow diagram illustrating a method for providing AI adjusted ROI encoding for improved license plate text clarity in recorded video.

FIG. 13 is a flow diagram illustrating a method for tracking object locations to enable ROI detection to be performed at frame intervals.

FIG. 14 is a flow diagram illustrating a method for applying a positive offset to the general encoding parameters to provide a consistent bitrate.

FIG. 15 is a flow diagram illustrating a method for filtering out license plate locations based on distance.

### DETAILED DESCRIPTION OF THE EMBODIMENTS

Embodiments of the present invention include providing AI adjusted ROI encoding for improved license plate text clarity in recorded video that may (i) implement vehicle detection in combination with license plate detection, (ii) implement one neural network to detect vehicles and another neural network to detect license plate, (iii) enable text clarity in bandwidth limited video, (iv) enable text clarity while conserving file size for a moving scene, (v) filter out text based on distance, (vi) apply different encoding parameters at a block level, (vii) reduce video bitrate outside of a license plate region, (viii) enhance text clarity for road signs, (ix) update license plate locations at intervals using object tracking and/or (x) be implemented as one or more integrated circuits.

Embodiments of the present invention may be configured to enhance text clarity in encoded video. Different encoding parameters may be selected for different regions of a video frame. The encoding parameters may be selected for particular areas of encoding blocks (e.g., at a macroblock level and/or at a Coding Tree Block (CTB) level). Selecting different encoding parameters for different block regions in a video frame may preserve a bitrate of a video (e.g., keep an output file size constant), while enhancing a legibility of text in the encoded video frames.

Embodiments of the present invention may be configured to detect one or more vehicles in a video frame (e.g., a raw video frame, an unencoded video frame, a video frame that has undergone pre-processing, a downscaled video frame, an uncompressed video frames, etc.). After a vehicle is detected, license plate detection may be performed within the location of the vehicle. Performing vehicle detection first may limit the search region for the license plate to a subsection of the video frames. Limiting the search region may enable detection results to be generated faster than searching an entire video frame and/or prevent false positive detection of license plates (e.g., license plates hanging on a wall, detecting other text that appears similar to a license plate, detecting discarded license plates, etc.). The blocks that correspond to the location of a license plate may be selected as a region of interest. Multiple license plates may be detected in each video frame. Settings for the encoding parameters may be selected based on the region(s) of interest detected. Embodiments of the present invention may implement vehicle detection, license plate detection and region of interest (ROI)-based video recording.

In some embodiments, one or more neural networks may be implemented. The neural network(s) may be configured to perform the vehicle detection and/or the license plate detection. In one example, a first neural network may be trained and implemented to detect vehicles and/or determine a distance to the vehicle. In another example, a second neural network may be trained and implemented to determine a location of the license plate within the location of the vehicle and/or determine particular encoding blocks that correspond to the license plate. The particular types of neural networks implemented and/or the training data used to enable the neural networks may be varied according to the design criteria of a particular implementation.

Embodiments of the present invention may be configured to provide a solution to encoded video frames captured by vehicle-mounted cameras not providing sufficiently clear text of license plates on other moving vehicles. For example, vehicle-mounted cameras may be bandwidth limited (e.g., streaming video over wireless networks such as 4G/5G/LTE) and/or have limited power budgets, which may limit a processing capability and/or limit a video bitrate of the encoded video output. The AI adjusted ROI encoding system may enable the average video bitrate to be relatively consistent (e.g., consistent between video frames where no license plates are detected and video frames where license plates are detected). The AI adjusted ROI encoding system may be configured to detect a bounding box location of a license plate (e.g., a relatively small area of the video frame) and apply ROI encoding. The ROI encoding may be selected to provide clear text. For example, providing clear text may be a trade-off with providing subjective video quality. In some embodiments, a higher quantization parameter (e.g., QP) may be selected that may provide worse video quality in other portions of the encoded video frame that may be outside of the license plate region of interest. Providing worse video quality outside of the license plate region of interest may keep the video bitrate relatively unchanged. For example, the AI adjusted ROI encoding may enable legible text using a lower resolution CMOS image sensor (e.g., 1080p30 video) instead of relying on higher bitrate video (e.g., double or more) from a higher resolution CMOS sensor (e.g., 4K) to record license plate text with better clarity. The lower bitrate video generated may be implemented at a lower cost and/or lower power than a higher resolution image sensor, and also save network bandwidth (e.g., to upload encoded video to a cloud service).

Embodiments of the present invention may combine vehicle detection with license plate detection. For example, a neural network may implement vehicle detection to determine a location for a sub-region of a video frame comprising a vehicle first, and then a neural network (e.g., a separate neural network) may detect the license plate within the bounding box of the vehicle detected. Applying both vehicle detection and then license plate detection may provide accuracy in detecting a license plate (e.g., prevent false positives) and increase a speed of license plate detection (e.g., compared to applying license plate detection on an entire video frame). The computer vision operations may be performed on raw and/or uncompressed video frames (e.g., video frames in a YUV format) to determine a bounding box location of the vehicle license plate. Then encoding may be applied to provide text clarity within the license plate bounding box by adjusting the ROI encoding parameters (e.g., CTB for H.265 or macroblock (MB) for H.264 encoding), while maintaining a consistent average video bitrate. Keeping the video bitrate relatively unchanged (e.g., whether license plates are detected in the video frames or not), may save bits from the video file storage. For example, keeping the average bitrate low may save costs on storage capacity and/or network bandwidth.

Providing license plate detection to ensure text clarity in the encoded video frames may enable license plate characters to be legible in the encoded video frames. In one example, legible text may be beneficial to enable an end user (e.g., a police officer, an insurance investigator, etc.) to view and recognize the text of the license plate directly from the video output. Viewing legible text directly from the video output may be easier and more convincing than relying on the output of a license plate reader system and/or an optical character recognition system (OCR). For example, license plate readers and OCR may provide text output (e.g., as a separate data stream, a separate file, as metadata for a video, etc.), which may contain errors that cannot be verified without the source video also being available. Furthermore, storing text output of license plate directly has privacy implications (e.g., personal identifying information may have stringent data protection protocols). For example, scraping a database of OCR text results may be easier to perform than visually inspecting video to read the actual text in the video content.

After the car (or vehicle) detection is performed and the license plate is detected within the vehicle bounding box, the ROI encoding parameters may be applied. Encoding blocks (e.g., CTB for H.265 or MB for H.264) may be detected that correspond to the license plate location. For example, the encoding parameters (e.g., may be selected for the entire video frame and an offset may be applied to a subset of the parameters used for encoding that correspond to the encoding block locations of the license plate. A negative offset value may be applied to the QP within the region of interest. The negative offset may reduce the QP, which may encode the region of interest with better quality. For example, most of the encoded video frame may be encoded using the selected QP and only the smaller portion(s) of the encoded video frame that correspond to the ROI(s) may be encoded using the offset QP values.

The encoding parameters (e.g., QP values) may be parameters that may be changed in real-time (e.g., on the fly). For example, CTB may correspond to a block of the image/video frame or a MB may correspond to a block of the image/video frame. The AI adjusted ROI encoding may be configured to adjust the block level parameters in real-time in response to detecting the locations of the license plates. Modifying the encoding parameters in real-time may be particularly effective for video data captured where the camera system is moving, and other objects in the camera field of view are moving (e.g., due to lots of movement, the video content may be constantly changing from frame to frame).

In some embodiments, the license plates may be detected on each video frame. For example, detecting each license plate location in each video frame may provide a highest level of accuracy for the license plate locations. In some embodiments, license plate locations may be detected at pre-defined intervals. For example, the license plate locations may be detected every 2nd video frame, every 4th video frame, every fraction of a second, etc. Generally, in order for tracking to be implemented effectively, the license plate locations may be performed at a relatively small frame interval (e.g., if there are too many frames in between detections, unless a car is moving extremely slowly, the tracking algorithm may not work due to large differences in object locations). Object tracking and/or predictive tracking of objects may be implemented to estimate the license plate locations in between the license plate detection intervals. For example, estimating license plate locations may save computational resources (e.g., the neural network may not operate on every video frame) compared to detecting license plate locations in each video frame. For example, tracking may comprise determining a speed and/or direction of travel of an object (e.g., a trajectory of an object) to estimate a location of an object in future video frames based on an analysis of the movement of an object over of a number of previously captured video frames.

In some embodiments, the AI adjusted ROI encoding may maintain a stable average bitrate by increasing the QP for portions of the video frame outside of the ROI. For example, increasing the QP for the majority of the video frame (e.g., the region outside of the ROI) may compensate for lowering the QP using the negative offset within the license plate area. Generally, the license plate location(s) may correspond to a relatively small portion of the video frames. For example, any increase in QP to compensate for the negative QP offset within the license plate location may be relatively small. The video quality effect of the QP increase outside of the ROI may be imperceptible to human eyes.

The ROI may be a total block area of the license plate. For example, the ROI may comprise several squares (e.g., encoding blocks) that may be smaller than the bounding box for the license plate. The bounding box for the license plate may be a rectangle comprising a number of pixels (e.g., width*height). Each of the encoding blocks may be a particular number of pixels to form a square. Each of the encoding blocks may be a sub-portion of the total number of pixels within the bounding box. Generally, most vehicles may be approximately the same size and/or have sizes within a similar range of sizes. In some embodiments, the size of the bounding box of the vehicle may be proportional to a distance of the vehicle from the image sensor.

In some embodiments, the AI adjusted ROI encoding may perform filtering to each of the license plate bounding boxes. The filtering may be configured to remove license plates determined to be too far from the image sensor (e.g., too far from the ego vehicle). For example, far away license plates may not have legible text in the uncompressed video. Applying the QP value offset may not make illegible text from the uncompressed video into legible text. By ignoring license plates that may not result in legible text, computational resources may be conserved. In some embodiments, the QP value offset may be adaptive to the distance to the license plate detected. For example, for each of the remaining (e.g., after filtering) license plates, individual adaptive QP offset values may be determined. The individual adaptive QP offset values may be selected according to the distance from the ego vehicle to ensure each of the license plates are readable.

In some embodiments, the AI adjusted ROI encoding may be extended to other types of text. For example, a bounding box of traffic signs may be used to enhance a clarity of text on traffic signs. Other types of signs (e.g., text painted on roads, highway signs, building signs, etc.) may be detected to enable clarity of text in the encoded video frames. For example, a bounding box of the sign may be detected, then a text location may be determined and the encoding parameters may be selected to provide clear text for the signs in the encoded video frames. The types of signage detected for AI adjusted ROI encoding may be varied according to the design criteria of a particular implementation.

Generally, the text clarity provided by embodiments of the present invention may comprise a prevention of loss of data from the uncompressed video frames. For example, the uncompressed video frames may comprise the available video information (e.g., the data comprising all information with the best available clarity and/or image quality). The text clarity provided by embodiments of the present invention may reduce an amount of loss from the video data in the uncompressed video frames during encoding. The data loss prevention may be limited to the particular regions of interest (e.g., license plate data and/or other text determined to be of interest). In some embodiments, video processing may be performed to enhance text quality (e.g., using AI-based super-resolution operations). However, AI-based text enhancement may detect and redraw text based on probability. If the source video data (e.g., the uncompressed video frames) do not show clear text, then AI-based text enhancement may be a game of probability, which may generate undesirable effects and/or visual artifacts and/or introduce errors.

Higher loss in video encoding may generate blocky, blurry video and/or other artifacts that result in text in the video being unrecognizable by human eyes, or hard to be recognized by AI detection if the text is encoded at low bitrate video. The ROI encoding implemented by embodiments of the present invention may reduce the loss to generate the output encoded video frames with text that may appear as good as the text in the uncompressed video frames. For example, without ROI encoding, the encoder may allocate bits evenly in the full video frame. Since the full video frame may have motion, determining which area has data that may be more important to have higher clarity may be difficult, which may result in the encoded video quality loss in the license plate area being large, compared to the uncompressed video frames.

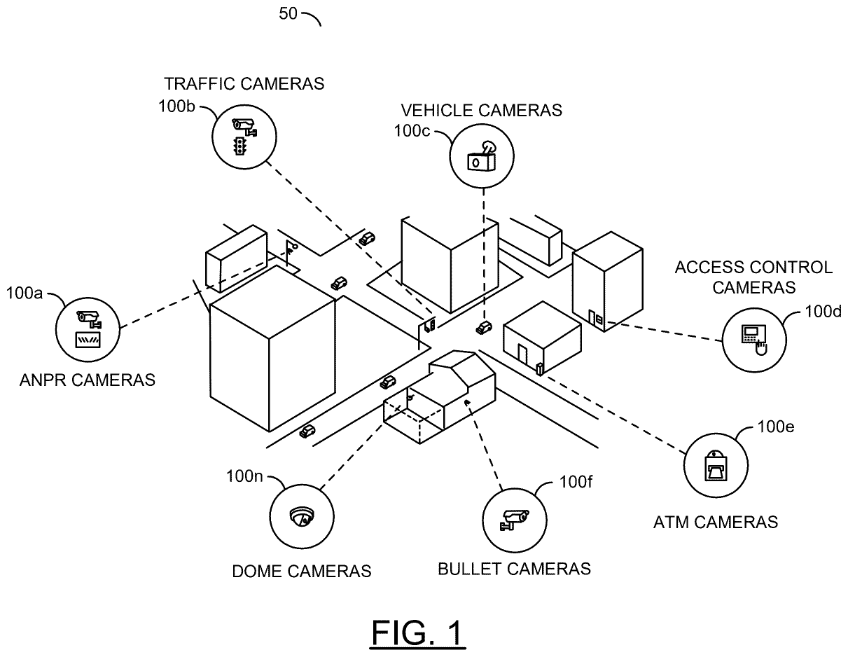

Referring to FIG. 1, a diagram illustrating examples of cameras that may implement AI adjusted ROI encoding for improved license plate text clarity in recorded video in accordance with example embodiments of the invention. An overhead view of an area 50 is shown. In the example shown, the area 50 may be an outdoor location. Streets, vehicles and buildings are shown.

Devices 100a-100n are shown at various locations in the area 50. The devices 100a-100n may each implement an edge device. The edge devices 100a-100n may comprise smart IP cameras (e.g., camera systems). The edge devices 100a-100n may comprise low power technology designed to be deployed in embedded platforms at the edge of a network (e.g., microprocessors running on sensors, cameras, or other battery-powered devices), where power consumption is a critical concern. In an example, the edge devices 100a-100n may comprise various traffic cameras and intelligent transportation systems (ITS) solutions.

The edge devices 100a-100n may be implemented for various applications. In the example shown, the edge devices 100a-100n may comprise automated number plate recognition (ANPR) cameras 100a, traffic cameras 100b, vehicle cameras 100c, access control cameras 100d, automatic teller machine (ATM) cameras 100e, bullet cameras 100f, dome cameras 100n, etc. In an example, the edge devices 100a-100n may be implemented as traffic cameras and intelligent transportation systems (ITS) solutions designed to enhance roadway security with a combination of person and vehicle detection, vehicle make/model recognition, and automatic number plate recognition (ANPR) capabilities.

In the example shown, the area 50 may be an outdoor location. In some embodiments, the edge devices 100a-100n may be implemented at various indoor locations. In an example, edge devices 100a-100n may incorporate a convolutional neural network in order to be utilized in security (surveillance) applications and/or access control applications. In an example, the edge devices 100a-100n implemented as security camera and access control applications may comprise battery-powered cameras, doorbell cameras, outdoor cameras, indoor cameras, etc. The security camera and access control applications may realize performance benefits from application of a convolutional neural network in accordance with embodiments of the invention. In an example, an edge device utilizing a convolutional neural network in accordance with an embodiment of the invention may take massive amounts of image data and make on-device inferences to obtain useful information (e.g., multiple time instances of images per network execution) with reduced bandwidth and/or reduced power consumption. In another example, security (surveillance) applications and/or location monitoring applications (e.g., trail cameras) may benefit from a large amount of optical zoom. The design, type and/or application performed by the edge devices 100a-100n may be varied according to the design criteria of a particular implementation.

The camera systems 100a-100n may capture video in bandwidth limited environments in the outdoor location area 50. For example, one or more of the camera systems 100a-100n may be configured to connect to wireless network (e.g., 4G/5G/LTE), which may be bandwidth limited compared to a hard-wired connection (e.g., Ethernet). In some embodiments, the ATM cameras 100e and/or the access control cameras 100d may be stationary cameras suitable for hard-wired connections, but may also be configured to connect to wireless connections (e.g., for ease of installation and/or for cost-savings). The environment in the outdoor location area 50 may change in real-time (e.g., capture scenes that may comprise moving objects). The vehicle cameras 100c may be particularly likely to capture moving scenes (e.g., a vehicle may move resulting in continually changing scenes). Action cameras may further be likely to capture moving scenes. Scenes with high-speed moving objects may be susceptible to text that may be difficult to read after encoding. Each of the camera systems 100a-100n may be configured to implement the AI adjusted ROI encoding.

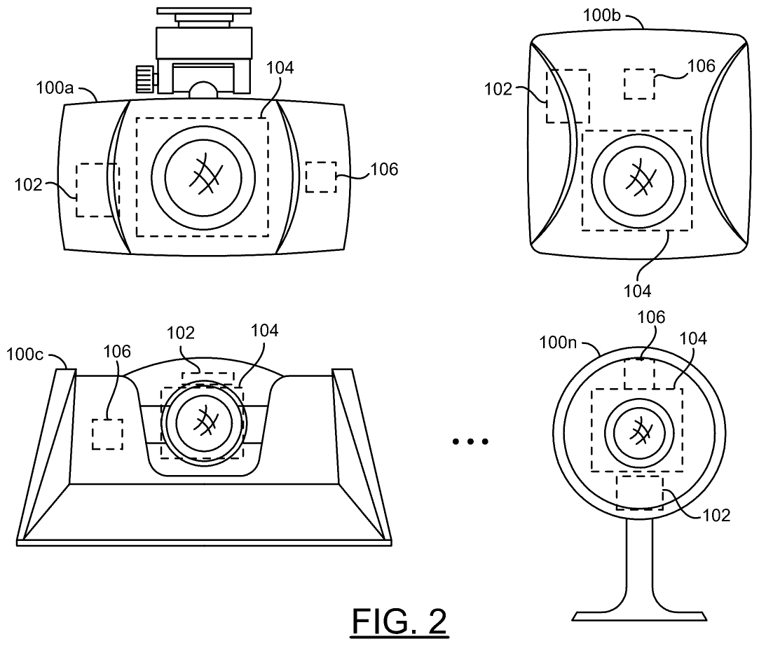

Referring to FIG. 2, a diagram illustrating example edge device cameras is shown. The camera systems 100a-100n are shown. Each camera device 100a-100n may have a different style and/or use case. For example, the camera 100a may be an action camera, the camera 100b may be a ceiling mounted security camera, the camera 100n may be a webcam, etc. Other types of cameras may be implemented (e.g., home security cameras, battery powered cameras, doorbell cameras, stereo cameras, etc.). In some embodiments, the camera systems 100a-100n may be stationary cameras (e.g., installed and/or mounted at a single location). In some embodiments, the camera systems 100a-100n may be handheld cameras. In some embodiments, the camera systems 100a-100n may be configured to pan across an area, may be attached to a mount, a gimbal, a camera rig, etc. The design/style of the cameras 100a-100n may be varied according to the design criteria of a particular implementation.

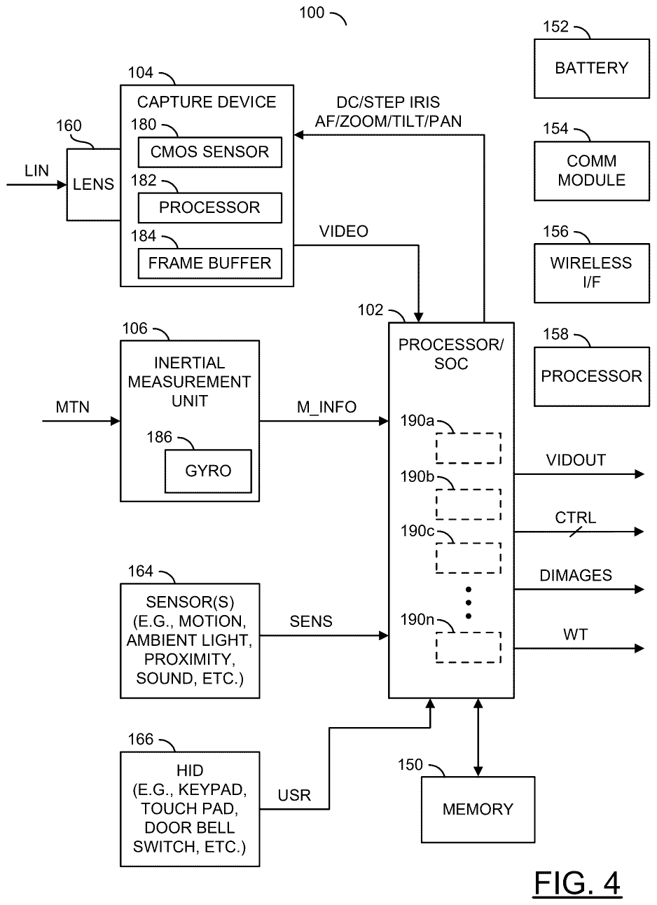

Each of the camera systems 100a-100n may comprise a block (or circuit) 102, a block (or circuit) 104 and/or a block (or circuit) 106. The circuit 102 may implement a processor. The circuit 104 may implement a capture device. The circuit 106 may implement an inertial measurement unit (IMU). The camera systems 100a-100n may comprise other components (not shown). Details of the components of the cameras 100a-100n may be described in association with FIG. 4.

The processor 102 may be configured to implement an artificial neural network (ANN). In an example, the ANN may comprise a convolutional neural network (CNN). The processor 102 may be configured to implement a video encoder. The processor 102 may be configured to process the pixel data arranged as video frames. The capture device 104 may be configured to capture pixel data that may be used by the processor 102 to generate video frames. The IMU 106 may be configured to generate movement data (e.g., vibration information, an amount of camera shake, panning direction, etc.). In some embodiments, a structured light projector may be implemented for projecting a speckle pattern onto the environment. The capture device 104 may capture the pixel data comprising a background image (e.g., the environment) with the speckle pattern. While each of the cameras 100a-100n are shown without implementing a structured light projector, some of the cameras 100a-100n may be implemented with a structured light projector (e.g., cameras that implement a sensor that capture IR light).

The cameras 100a-100n may be edge devices. The processor 102 implemented by each of the cameras 100a-100n may enable the cameras 100a-100n to implement various functionality internally (e.g., at a local level). For example, the processor 102 may be configured to perform object/event detection (e.g., computer vision operations), 3D reconstruction, liveness detection, depth map generation, video encoding, electronic image stabilization and/or video transcoding on-device). For example, even advanced processes such as computer vision and 3D reconstruction may be performed by the processor 102 without uploading video data to a cloud service in order to offload computation-heavy functions (e.g., computer vision, video encoding, video transcoding, etc.).

In some embodiments, multiple camera systems may be implemented (e.g., camera systems 100a-100n may operate independently from each other). For example, each of the cameras 100a-100n may individually analyze the pixel data captured and perform the event/object detection locally. In some embodiments, the cameras 100a-100n may be configured as a network of cameras (e.g., security cameras that send video data to a central source such as network-attached storage and/or a cloud service). The locations and/or configurations of the cameras 100a-100n may be varied according to the design criteria of a particular implementation.

The capture device 104 of each of the camera systems 100a-100n may comprise a single lens (e.g., a monocular camera). The processor 102 may be configured to accelerate preprocessing of the speckle structured light for monocular 3D reconstruction. Monocular 3D reconstruction may be performed to generate depth images and/or disparity images without the use of stereo cameras.

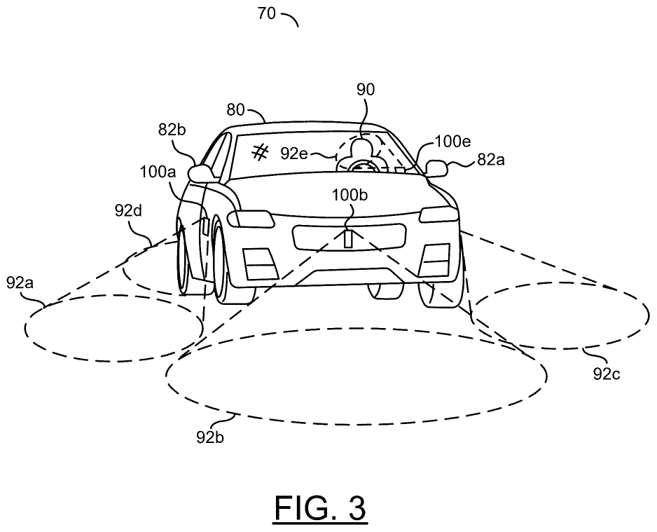

Referring to FIG. 3, a diagram illustrating an example embodiment of the present invention configured to provide an all-around view of a vehicle is shown. An external environment 70 with a vehicle 80 is shown. In the example shown, the vehicle 80 may be a personal vehicle. In one example, the vehicle 80 may be a commercial vehicle (e.g., package delivery, a service van, a public transport van, etc.). In some embodiments, the vehicle 80 may be a commercial truck (e.g., a semi-trailer truck). In some embodiments, the vehicle 80 may be a pickup truck (e.g., a light duty vehicle, a medium duty vehicle, a heavy duty vehicle, etc.). In some embodiments, the vehicle 80 may be a commuter and/or home use vehicle (e.g., a family vehicle such as a sedan, a minivan, a SUV, a crossover, etc.). The vehicle 80 may be an internal combustion engine (ICE) vehicle, a diesel vehicle, a hybrid electric vehicle, a battery electric vehicle, etc. The type of the vehicle 80 implemented may be varied according to the design criteria of a particular implementation.

External side view mirrors 82a-82b are shown on the vehicle 80. The side view mirror 82a may be a side view mirror on the driver side of the vehicle 80. The side view mirror 82b may be a side view mirror on the passenger side of the vehicle 80. A driver 90 is shown in the interior of the vehicle 80. The vehicle 80 may comprise devices 100a-100n. The devices 100a-100n may be camera systems. Camera systems 100a-100b are shown integrated as part of the vehicle 80. The camera system 100a is shown on a passenger side of the vehicle 80. The camera system 100a is shown below the passenger side view mirror 82b. The camera system 100b is shown on the front grille of the vehicle 80. In the perspective of the vehicle 80 shown, three of the camera systems 100a-100b and 100e may be visible. However, one of the camera systems 100a-100n may be implemented at a level below the driver side view mirror 82a (not visible from the perspective of the external view shown). Other camera systems 100a-100n may be located throughout the exterior and/or interior of the vehicle 80. The camera systems 100a-100n may be configured to capture an all-around view of the environment 70 near the vehicle 80.

Dashed lines 92a-92e are shown. In the example shown, the dashed lines 92a are shown extending from the camera system 100a and the dashed lines 92b are shown extending from the camera system 100b towards the exterior of the vehicle. The dashed lines 92c-92d may similarly extend from respective camera systems 100c-100d (not visible from the perspective shown). The dashed lines 92a-92d may provide an illustrative representation of fields of view captured by each of the camera systems 100a-100d. The fields of view 92a-92d together may provide an all-around view of the environment near the vehicle 80.

The all-around view 92a-92d is shown. In an example, the all-around view 92a-92d may enable an all-around view (AVM) system. The AVM system may comprise four cameras (e.g., each camera may comprise a combination of one of the camera systems 100a-100n and/or a stereo pair of the lenses implemented by the camera systems 100a-100n). In the perspective shown in the environment 70, the camera system 100a and the camera system 100b may each be one of the four cameras and the other two cameras may not be visible. In an example, the camera system 100b may be a camera located on the front grille of the vehicle 80, one of the cameras may be on the rear (e.g., over the license plate), the camera system 100a may be located below the side view mirror 82b on the passenger side and one of the cameras may be located below the side view mirror 82a on the driver side. The arrangement of the cameras may be varied according to the design criteria of a particular implementation.

The dashed lines 92e are shown are shown extending from the camera system 100e towards an interior of the vehicle 80. The camera system 100e may be a cabin monitoring camera system. The camera system 100e may be configured to capture the field of view 92e of the cabin of the vehicle 80. The field of view 92e may be directed towards the driver 90. In some embodiments, the field of view 92e may be directed towards the driver 90 and/or other occupants of the vehicle 80.

In some embodiments, each of the camera systems 100a-100e may be configured to capture pixel data arranged as video frames. In some embodiments, each of the camera systems 100a-100d providing the all-around view 92a-92d and/or the camera system 100e providing the cabin view may implement a fisheye lens (e.g., may capture a video frame with a 180 degree angular aperture). The all-around view 92a-92d is shown providing a field of view coverage all around the vehicle 80. For example, the portion of the all-around view 92a may provide coverage for a passenger side of the vehicle 80, the portion of the all-around view 92b may provide coverage for a front of the vehicle 80, the portion of the all-around view 92c may provide coverage for a driver side of the vehicle 80 and the portion of the all-around view 92d may provide coverage for a rear of the vehicle 80. Each portion of the all-around view 92a-92d may be one field of view of a camera mounted to the vehicle 80. Each portion of the all-around view 92a-92d may be dewarped and stitched together by the video processors to provide an enhanced video frame that represents a top-down view near the vehicle 80. The camera systems 100a-100d may be configured to implement a Bird's Eye View Transformer network (e.g., a deep learning model designed to generate BEV representations from multi-camera images). In an example, the all-around view 92a-92d may be used to provide a representation of a bird's-eye view of the vehicle 80.

The camera systems 100a-100e may provide a representative example of the mechanism for image acquisition. In one example, the camera systems 100a-100e may be implemented as monocular cameras. In another example, the camera systems 100a-100e may be implemented as stereo cameras (e.g., two capture devices implemented in a stereo pair). In some embodiments, the stereo cameras may be horizontally oriented. In some embodiments, the stereo cameras may be vertically oriented. In one example, four stereo cameras (e.g., eight capture devices) may be implemented, with one on each side of the vehicle 80. In some embodiments, the camera systems 100a-100n may be installed as an aftermarket product. For example, the vehicle 80 may be sold without a camera and one or more of the camera systems 100a-100n may be installed on the vehicle 80. The implementation and/or locations of the camera systems 100a-100e on the vehicle 80 and/or the orientation of the camera systems 100a-100e may be varied according to the design criteria of a particular implementation.

The camera systems 100a-100d may capture scenes comprising continuous and/or near continuous motion in the external environment 70. For example, the vehicle 80 may travel through changing scenery with objects that may move relative to the vehicle 80. Each of the camera systems 100a-100e may be configured to implement the AI adjusted ROI encoding. The moving objects captured by the camera systems 100a-100e may result in text that may be difficult to read. The AI adjusted ROI encoding may enable the encoded video frames to store legible text while maintaining a relatively constant bitrate.

Referring to FIG. 4, a block diagram illustrating a camera system is shown. The camera system (or apparatus) 100 may be a representative example of the cameras 100a-100n shown in association with FIG. 2 and/or the cameras 100a-100e shown in association with FIG. 3. The camera system 100 may comprise the processor/SoC 102, the capture device 104, and the IMU 106.

The camera system 100 may further comprise a block (or circuit) 150, a block (or circuit) 152, a block (or circuit) 154, a block (or circuit) 156, a block (or circuit) 158, a block (or circuit) 160, a block (or circuit) 164, and/or a block (or circuit) 166. The circuit 150 may implement a memory. The circuit 152 may implement a battery. The circuit 154 may implement a communication device. The circuit 156 may implement a wireless interface. The circuit 158 may implement a general purpose processor. The block 160 may implement an optical lens. The circuit 164 may implement one or more sensors. The circuit 166 may implement a human interface device (HID). In some embodiments, the camera system 100 may comprise the processor/SoC 102, the capture device 104, the IMU 106, the memory 150, the lens 160, the sensors 164, the battery 152, the communication module 154, the wireless interface 156 and the processor 158. In another example, the camera system 100 may comprise processor/SoC 102, the capture device 104, the IMU 106, the processor 158, the lens 160, and the sensors 164 as one device, and the memory 150, the battery 152, the communication module 154, and the wireless interface 156 may be components of a separate device. The camera system 100 may comprise other components (not shown). The number, type and/or arrangement of the components of the camera system 100 may be varied according to the design criteria of a particular implementation.

In some embodiments, the processor 102 may be implemented as a video processor. In an example, the processor 102 may be configured to receive triple-sensor video input with high-speed SLVS/MIPI-CSI/LVCMOS interfaces. In some embodiments, the processor 102 may be configured to perform depth sensing in addition to generating video frames. In an example, the depth sensing may be performed in response to depth information and/or vector light data captured in the video frames. In some embodiments, the processor 102 may be implemented as a dataflow vector processor. In an example, the processor 102 may comprise a highly parallel architecture configured to perform image/video processing and/or radar signal processing.

The memory 150 may store data. The memory 150 may implement various types of memory including, but not limited to, a cache, flash memory, memory card, random access memory (RAM), dynamic RAM (DRAM) memory, etc. The type and/or size of the memory 150 may be varied according to the design criteria of a particular implementation. The data stored in the memory 150 may correspond to a video file, motion information (e.g., readings from the sensors 164), video fusion parameters, image stabilization parameters, user inputs, computer vision models, feature sets, radar data cubes, radar detections and/or metadata information. In some embodiments, the memory 150 may store reference images. The reference images may be used for computer vision operations, 3D reconstruction, auto-exposure, etc. In some embodiments, the reference images may comprise reference structured light images.

The processor/SoC 102 may be configured to execute computer readable code and/or process information. In various embodiments, the computer readable code may be stored within the processor/SoC 102 (e.g., microcode, etc.) and/or in the memory 150. In an example, the processor/SoC 102 may be configured to execute one or more artificial neural network models (e.g., facial recognition CNN, object detection CNN, object classification CNN, 3D reconstruction CNN, liveness detection CNN, etc.) stored in the memory 150. In an example, the memory 150 may store one or more directed acyclic graphs (DAGs) and one or more sets of weights and biases defining the one or more artificial neural network models. In yet another example, the memory 150 may store instructions to perform transformational operations (e.g., Discrete Cosine Transform, Discrete Fourier Transform, Fast Fourier Transform, etc.). The processor/SoC 102 may be configured to receive input from and/or present output to the memory 150. The processor/SoC 102 may be configured to present and/or receive other signals (not shown). The number and/or types of inputs and/or outputs of the processor/SoC 102 may be varied according to the design criteria of a particular implementation. The processor/SoC 102 may be configured for low power (e.g., battery) operation.

The battery 152 may be configured to store and/or supply power for the components of the camera system 100. The dynamic driver mechanism for a rolling shutter sensor may be configured to conserve power consumption. Reducing the power consumption may enable the camera system 100 to operate using the battery 152 for extended periods of time without recharging. The battery 152 may be rechargeable. The battery 152 may be built-in (e.g., non-replaceable) or replaceable. The battery 152 may have an input for connection to an external power source (e.g., for charging). In some embodiments, the apparatus 100 may be powered by an external power supply (e.g., the battery 152 may not be implemented or may be implemented as a back-up power supply). The battery 152 may be implemented using various battery technologies and/or chemistries. The type of the battery 152 implemented may be varied according to the design criteria of a particular implementation.

The communications module 154 may be configured to implement one or more communications protocols. For example, the communications module 154 and the wireless interface 156 may be configured to implement one or more of, IEEE 102.11, IEEE 102.15, IEEE 102.15.1, IEEE 102.15.2, IEEE 102.15.3, IEEE 102.15.4, IEEE 102.15.5, IEEE 102.20, Bluetooth®, and/or ZigBee®. In some embodiments, the communication module 154 may be a hard-wired data port (e.g., a USB port, a mini-USB port, a USB-C connector, HDMI port, an Ethernet port, a DisplayPort interface, a Lightning port, etc.). In some embodiments, the wireless interface 156 may also implement one or more protocols (e.g., GSM, CDMA, GPRS, UMTS, CDMA2000, 3GPP LTE, 4G/HSPA/WiMAX, SMS, etc.) associated with cellular communication networks. In embodiments where the camera system 100 is implemented as a wireless camera, the protocol implemented by the communications module 154 and wireless interface 156 may be a wireless communications protocol. The type of communications protocols implemented by the communications module 154 may be varied according to the design criteria of a particular implementation.

The communications module 154 and/or the wireless interface 156 may be configured to generate a broadcast signal as an output from the camera system 100. The broadcast signal may send video data, disparity data and/or a control signal(s) to external devices. For example, the broadcast signal may be sent to a cloud storage service (e.g., a storage service capable of scaling on demand). In some embodiments, the communications module 154 may not transmit data until the processor/SoC 102 has performed video analytics and/or radar signal processing to determine that an object is in the field of view of the camera system 100.

In some embodiments, the communications module 154 may be configured to generate a manual control signal. The manual control signal may be generated in response to a signal from a user received by the communications module 154. The manual control signal may be configured to activate the processor/SoC 102. The processor/SoC 102 may be activated in response to the manual control signal regardless of the power state of the camera system 100.

In some embodiments, the communications module 154 and/or the wireless interface 156 may be configured to receive a feature set. The feature set received may be used to detect events and/or objects. For example, the feature set may be used to perform the computer vision operations. The feature set information may comprise instructions for the processor 102 for determining which types of objects correspond to an object and/or event of interest.

In some embodiments, the communications module 154 and/or the wireless interface 156 may be configured to receive user input. The user input may enable a user to adjust operating parameters for various features implemented by the processor 102. In some embodiments, the communications module 154 and/or the wireless interface 156 may be configured to interface (e.g., using an application programming interface (API) with an application (e.g., an app). For example, the app may be implemented on a smartphone to enable an end user to adjust various settings and/or parameters for the various features implemented by the processor 102 (e.g., set video resolution, select frame rate, select output format, set tolerance parameters for 3D reconstruction, etc.).

The processor 158 may be implemented using a general purpose processor circuit. The processor 158 may be operational to interact with the video processing circuit 102 and the memory 150 to perform various processing tasks. The processor 158 may be configured to execute computer readable instructions. In one example, the computer readable instructions may be stored by the memory 150. In some embodiments, the computer readable instructions may comprise controller operations. Generally, input from the sensors 164 and/or the human interface device 166 are shown being received by the processor 102. In some embodiments, the general purpose processor 158 may be configured to receive and/or analyze data from the sensors 164 and/or the HID 166 and make decisions in response to the input. In some embodiments, the processor 158 may send data to and/or receive data from other components of the camera system 100 (e.g., the battery 152, the communication module 154 and/or the wireless interface 156). In some embodiments, the processor 158 may implement an integrated digital signal processor (IDSP). For example, the IDSP 158 may be configured to implement a warp engine. Which of the functionality of the camera system 100 is performed by the processor 102 and the general purpose processor 158 may be varied according to the design criteria of a particular implementation.

The lens 160 may be attached to the capture device 104. The capture device 104 may be configured to receive an input signal (e.g., LIN) via the lens 160. The signal LIN may be a light input (e.g., an analog image). The lens 160 may be implemented as an optical lens. The lens 160 may provide a zooming feature and/or a focusing feature. The capture device 104 and/or the lens 160 may be implemented, in one example, as a single lens assembly. In another example, the lens 160 may be a separate implementation from the capture device 104.

The capture device 104 may be configured to convert the input light LIN into computer readable data. The capture device 104 may capture data received through the lens 160 to generate raw pixel data. In some embodiments, the capture device 104 may capture data received through the lens 160 to generate bitstreams (e.g., generate video frames). For example, the capture devices 104 may receive focused light from the lens 160. The lens 160 may be directed, tilted, panned, zoomed and/or rotated to provide a targeted view from the camera system 100 (e.g., a view for a video frame, a view for a panoramic video frame captured using multiple camera systems 100a-100n, a target image and reference image view for stereo vision, etc.). The capture device 104 may generate a signal (e.g., VIDEO). The signal VIDEO may be pixel data (e.g., a sequence of pixels that may be used to generate video frames). In some embodiments, the signal VIDEO may be video data (e.g., a sequence of video frames). The signal VIDEO may be presented to one of the inputs of the processor 102. In some embodiments, the pixel data generated by the capture device 104 may be uncompressed and/or raw data generated in response to the focused light from the lens 160. In some embodiments, the output of the capture device 104 may be digital video signals.

In an example, the capture device 104 may comprise a block (or circuit) 180, a block (or circuit) 182, and a block (or circuit) 184. The circuit 180 may be an image sensor. The circuit 182 may be a processor and/or logic. The circuit 184 may be a memory circuit (e.g., a frame buffer). The lens 160 (e.g., camera lens) may be directed to provide a view of an environment surrounding the camera system 100. The lens 160 may be aimed to capture environmental data (e.g., the light input LIN). The lens 160 may be a wide-angle lens and/or fish-eye lens (e.g., lenses capable of capturing a wide field of view). The lens 160 may be configured to capture and/or focus the light for the capture device 104. Generally, the image sensor 180 is located behind the lens 160. Based on the captured light from the lens 160, the capture device 104 may generate a bitstream and/or video data (e.g., the signal VIDEO).

The capture device 104 may be configured to capture video image data (e.g., light collected and focused by the lens 160). The capture device 104 may capture data received through the lens 160 to generate a video bitstream (e.g., pixel data for a sequence of video frames). In various embodiments, the lens 160 may be implemented as a fixed focus lens. A fixed focus lens generally facilitates smaller size and low power. In an example, a fixed focus lens may be used in battery powered, doorbell, and other low power camera applications. In some embodiments, the lens 160 may be directed, tilted, panned, zoomed and/or rotated to capture the environment surrounding the camera system 100 (e.g., capture data from the field of view). In an example, professional camera models may be implemented with an active lens system for enhanced functionality, remote control, etc.

The capture device 104 may transform the received light into a digital data stream. In some embodiments, the capture device 104 may perform an analog to digital conversion. For example, the image sensor 180 may perform a photoelectric conversion of the light received by the lens 160. The processor/logic 182 may transform the digital data stream into a video data stream (or bitstream), a video file, and/or a number of video frames. In an example, the capture device 104 may present the video data as a digital video signal (e.g., VIDEO). The digital video signal may comprise the video frames (e.g., sequential digital images and/or audio). In some embodiments, the capture device 104 may comprise a microphone for capturing audio. In some embodiments, the microphone may be implemented as a separate component (e.g., one of the sensors 164).

The video data captured by the capture device 104 may be represented as a signal/bitstream/data VIDEO (e.g., a digital video signal). The capture device 104 may present the signal VIDEO to the processor/SoC 102. The signal VIDEO may represent the video frames/video data. The signal VIDEO may be a video stream captured by the capture device 104. In some embodiments, the signal VIDEO may comprise pixel data that may be operated on by the processor 102 (e.g., a video processing pipeline, an image signal processor (ISP), etc.). The processor 102 may generate the video frames in response to the pixel data in the signal VIDEO.

The signal VIDEO may comprise pixel data arranged as video frames. In some embodiments, the signal VIDEO may be images comprising a background (e.g., objects and/or the environment captured) and the speckle pattern generated by a structured light projector. The signal VIDEO may comprise single-channel source images. The single-channel source images may be generated in response to capturing the pixel data using the monocular lens 160.

The image sensor 180 may receive the input light LIN from the lens 160 and transform the light LIN into digital data (e.g., the bitstream). For example, the image sensor 180 may perform a photoelectric conversion of the light from the lens 160. In some embodiments, the image sensor 180 may have extra margins that are not used as part of the image output. In some embodiments, the image sensor 180 may not have extra margins. In various embodiments, the image sensor 180 may be implemented as an RGB sensor, an RGB-IR sensor, an RCCB sensor, a monocular image sensor, stereo image sensors, a thermal sensor, an event-based sensor, etc. For example, the image sensor 180 may be any type of sensor configured to provide sufficient output for computer vision operations to be performed on the output data (e.g., neural network-based detection). In some embodiments, the image sensor 180 may be configured to generate an RGB-IR video signal. In an infrared light only illuminated field of view, the image sensor 180 may generate a monochrome (B/W) video signal. In a field of view illuminated by both IR light and visible light, the image sensor 180 may be configured to generate color information in addition to the monochrome video signal. In various embodiments, the image sensor 180 may be configured to generate a video signal in response to visible and/or infrared (IR) light.

In some embodiments, the camera sensor 180 may comprise a rolling shutter sensor or a global shutter sensor. In an example, the rolling shutter sensor 180 may implement an RGB-IR sensor. In some embodiments, the capture device 104 may comprise a rolling shutter IR sensor and an RGB sensor (e.g., implemented as separate components). In an example, the rolling shutter sensor 180 may be implemented as an RGB-IR rolling shutter complementary metal oxide semiconductor (CMOS) image sensor. In some embodiments, the image sensor 190 may be implemented as a CMOS sensor configured to implement a Bayer pattern. In one example, the rolling shutter sensor 180 may be configured to assert a signal that indicates a first line exposure time. In one example, the rolling shutter sensor 180 may apply a mask to a monochrome sensor. In an example, the mask may comprise a plurality of units containing one red pixel, one green pixel, one blue pixel, and one IR pixel. The IR pixel may contain red, green, and blue filter materials that effectively absorb all of the light in the visible spectrum, while allowing the longer infrared wavelengths to pass through with minimal loss. With a rolling shutter, as each line (or row) of the sensor starts exposure, all pixels in the line (or row) may start exposure simultaneously.

The processor/logic 182 may transform the bitstream into a human viewable content (e.g., video data that may be understandable to an average person regardless of image quality, such as the video frames and/or pixel data that may be converted into video frames by the processor 102). For example, the processor/logic 182 may receive pure (e.g., raw) data from the image sensor 180 and generate (e.g., encode) video data (e.g., the bitstream) based on the raw data. The capture device 104 may have the memory 184 to store the raw data and/or the processed bitstream. For example, the capture device 104 may implement the frame memory and/or buffer 184 to store (e.g., provide temporary storage and/or cache) one or more of the video frames (e.g., the digital video signal). In some embodiments, the processor/logic 182 may perform analysis and/or correction on the video frames stored in the memory/buffer 184 of the capture device 104. The processor/logic 182 may provide status information about the captured video frames. The IMU 106 may be configured to detect motion and/or movement of the camera system 100. The IMU 106 is shown receiving a signal (e.g., MTN). The signal MTN may comprise a combination of forces acting on the camera system 100. The signal MTN may comprise movement, vibrations, shakiness, a panning direction, jerkiness, etc. The signal MTN may represent movement in three dimensional space (e.g., movement in an X direction, a Y direction and a Z direction). The type and/or amount of motion received by the IMU 106 may be varied according to the design criteria of a particular implementation.

The IMU 106 may comprise a block (or circuit) 186. The circuit 186 may implement a motion sensor. In one example, the motion sensor 186 may be a gyroscope. The gyroscope 186 may be configured to measure the amount of movement. For example, the gyroscope 186 may be configured to detect an amount and/or direction of the movement of the signal MTN and convert the movement into electrical data. The IMU 106 may be configured to determine the amount of movement and/or the direction of movement measured by the gyroscope 186. The IMU 106 may convert the electrical data from the gyroscope 186 into a format readable by the processor 102. The IMU 106 may be configured to generate a signal (e.g., M_INFO). The signal M_INFO may comprise the measurement information in the format readable by the processor 102. The IMU 106 may present the signal M_INFO to the processor 102. The number, type and/or arrangement of the components of the IMU 106 and/or the number, type and/or functionality of the signals communicated by the IMU 106 may be varied according to the design criteria of a particular implementation.

The sensors 164 may implement a number of sensors including, but not limited to, motion sensors, ambient light sensors, proximity sensors (e.g., ultrasound, radar, passive infrared, lidar, etc.), audio sensors (e.g., a microphone), etc. In embodiments implementing a motion sensor, the sensors 164 may be configured to detect motion anywhere in the field of view monitored by the camera system 100 (or in some locations outside of the field of view). In various embodiments, the detection of motion may be used as one threshold for activating the capture device 104. The sensors 164 may be implemented as an internal component of the camera system 100 and/or as a component external to the camera system 100. In an example, the sensors 164 may be implemented as a passive infrared (PIR) sensor. In another example, the sensors 164 may be implemented as a smart motion sensor. In yet another example, the sensors 164 may be implemented as a microphone. In embodiments implementing the smart motion sensor, the sensors 164 may comprise a low resolution image sensor configured to detect motion and/or persons.

In various embodiments, the sensors 164 may generate a signal (e.g., SENS). The signal SENS may comprise a variety of data (or information) collected by the sensors 164. In an example, the signal SENS may comprise data collected in response to motion being detected in the monitored field of view, an ambient light level in the monitored field of view, and/or sounds picked up in the monitored field of view. However, other types of data may be collected and/or generated based upon design criteria of a particular application. The signal SENS may be presented to the processor/SoC 102. In an example, the sensors 164 may generate (assert) the signal SENS when motion is detected in the field of view monitored by the camera system 100. In another example, the sensors 164 may generate (assert) the signal SENS when triggered by audio in the field of view monitored by the camera system 100. In still another example, the sensors 164 may be configured to provide directional information with respect to motion and/or sound detected in the field of view. The directional information may also be communicated to the processor/SoC 102 via the signal SENS.

The HID 166 may implement an input device. For example, the HID 166 may be configured to receive human input. In one example, the HID 166 may be configured to receive a password input from a user. In another example, the HID 166 may be configured to receive user input in order to provide various parameters and/or settings to the processor 102 and/or the memory 150. In some embodiments, the camera system 100 may include a keypad, a touch pad (or screen), a doorbell switch, and/or other human interface devices (HIDs) 166. In an example, the sensors 164 may be configured to determine when an object is in proximity to the HIDs 166. In an example where the camera system 100 is implemented as part of an access control application, the capture device 104 may be turned on to provide images for identifying a person attempting access, and illumination of a lock area and/or for an access touch pad 166 may be turned on. For example, a combination of input from the HIDs 166 (e.g., a password or PIN number) may be combined with the liveness judgment and/or depth analysis performed by the processor 102 to enable two-factor authentication. The HID 166 may present a signal (e.g., USR) to the processor 102. The signal USR may comprise the input received by the HID 166.

In embodiments of the camera system 100 that implement a structured light projector, the structured light projector may comprise a structured light pattern lens and/or a structured light source. The structured source may be configured to generate a structured light pattern signal (e.g., a speckle pattern) that may be projected onto an environment near the camera system 100. The structured light pattern may be captured by the capture device 104 as part of the light input LIN. The structured light pattern lens may be configured to enable structured light generated by a structured light source of the structured light projector to be emitted while protecting the structured light source. The structured light pattern lens may be configured to decompose the laser light pattern generated by the structured light source into a pattern array (e.g., a dense dot pattern array for a speckle pattern).

In an example, the structured light source may be implemented as an array of vertical-cavity surface-emitting lasers (VCSELs) and a lens. However, other types of structured light sources may be implemented to meet design criteria of a particular application. In an example, the array of VCSELs is generally configured to generate a laser light pattern (e.g., the signal SLP). The lens is generally configured to decompose the laser light pattern to a dense dot pattern array. In an example, the structured light source may implement a near infrared (NIR) light source. In various embodiments, the light source of the structured light source may be configured to emit light with a wavelength of approximately 940 nanometers (nm), which is not visible to the human eye. However, other wavelengths may be utilized. In an example, a wavelength in a range of approximately 800-1000nm may be utilized.

The processor/SoC 102 may receive the signal VIDEO, the signal M_INFO, the signal SENS, and the signal USR. The processor/SoC 102 may generate one or more video output signals (e.g., VIDOUT), one or more control signals (e.g., CTRL), one or more depth data signals (e.g., DIMAGES) and/or one or more warp table data signals (e.g., WT) based on the signal VIDEO, the signal M_INFO, the signal SENS, the signal USR and/or other input. In some embodiments, the signals VIDOUT, DIMAGES, WT and CTRL may be generated based on analysis of the signal VIDEO and/or objects detected in the signal VIDEO. In some embodiments, the signals VIDOUT, DIMAGES, WT and CTRL may be generated based on analysis of the signal VIDEO, the movement information captured by the IMU 106 and/or the intrinsic properties of the lens 160 and/or the capture device 104.

In various embodiments, the processor/SoC 102 may be configured to perform one or more of feature extraction, object detection, object tracking, electronic image stabilization, 3D reconstruction, liveness detection and object identification. For example, the processor/SoC 102 may determine motion information and/or depth information by analyzing a frame from the signal VIDEO and comparing the frame to a previous frame. The comparison may be used to perform digital motion estimation. In some embodiments, the processor/SoC 102 may be configured to generate the video output signal VIDOUT comprising video data, the warp table data signal WT and/or the depth data signal DIMAGES comprising disparity maps and depth maps from the signal VIDEO. The video output signal VIDOUT the warp table data signal WT and/or the depth data signal DIMAGES may be presented to the memory 150, the communications module 154, and/or the wireless interface 156. In some embodiments, the video signal VIDOUT the warp table data signal WT and/or the depth data signal DIMAGES may be used internally by the processor 102 (e.g., not presented as output). In one example, the warp table data signal WT may be used by a warp engine implemented by a digital signal processor (e.g., the processor 158).

The signal VIDOUT may be presented to the communication module 154 and/or the wireless interface 156. In some embodiments, the signal VIDOUT may comprise encoded video frames generated by the processor 102. In some embodiments, the encoded video frames may comprise a full video stream (e.g., encoded video frames representing all video captured by the capture device 104). The encoded video frames may be encoded, cropped, stitched, stabilized and/or enhanced versions of the pixel data received from the signal VIDEO. In an example, the encoded video frames may be a high resolution, digital, encoded, de-warped, stabilized, cropped, blended, stitched and/or rolling shutter effect corrected version of the signal VIDEO.

In some embodiments, the signal VIDOUT may be generated based on video analytics (e.g., computer vision operations) performed by the processor 102 on the video frames generated. The processor 102 may be configured to perform the computer vision operations to detect objects and/or events in the video frames and then convert the detected objects and/or events into statistics and/or parameters. In one example, the data determined by the computer vision operations may be converted to the human-readable format by the processor 102. The data from the computer vision operations may be used to detect objects and/or events. The computer vision operations may be performed by the processor 102 locally (e.g., without communicating to an external device to offload computing operations). Similarly other video processing and/or encoding operations (e.g., stabilization, compression, stitching, cropping, rolling shutter effect correction, etc.) may be performed by the processor 102 locally. For example, the locally performed computer vision operations may enable the computer vision operations to be performed by the processor 102 and avoid heavy video processing running on back-end servers. Avoiding video processing running on back-end (e.g., remotely located) servers may preserve privacy.

In some embodiments, the signal VIDOUT may be data generated by the processor 102 (e.g., video analysis results, audio/speech analysis results, stabilized video frames, etc.) that may be communicated to a cloud computing service in order to aggregate information and/or provide training data for machine learning (e.g., to improve object detection, to improve audio detection, to improve liveness detection, etc.). In some embodiments, the signal VIDOUT may be provided to a cloud service for mass storage (e.g., to enable a user to retrieve the encoded video using a smartphone and/or a desktop computer). In some embodiments, the signal VIDOUT may comprise the data extracted from the video frames (e.g., the results of the computer vision), and the results may be communicated to another device (e.g., a remote server, a cloud computing system, etc.) to offload analysis of the results to another device (e.g., offload analysis of the results to a cloud computing service instead of performing all the analysis locally). The type of information communicated by the signal VIDOUT may be varied according to the design criteria of a particular implementation.

The signal CTRL may be configured to provide a control signal. The signal CTRL may be generated in response to decisions made by the processor 102. In one example, the signal CTRL may be generated in response to objects detected and/or characteristics extracted from the video frames. The signal CTRL may be configured to enable, disable, change a mode of operations of another device. In one example, a door controlled by an electronic lock may be locked/unlocked in response the signal CTRL. In another example, a device may be set to a sleep mode (e.g., a low-power mode) and/or activated from the sleep mode in response to the signal CTRL. In yet another example, an alarm and/or a notification may be generated in response to the signal CTRL. The type of device controlled by the signal CTRL, and/or a reaction performed by of the device in response to the signal CTRL may be varied according to the design criteria of a particular implementation.

The signal CTRL may be generated based on data received by the sensors 164 (e.g., a temperature reading, a motion sensor reading, etc.). The signal CTRL may be generated based on input from the HID 166. The signal CTRL may be generated based on behaviors of people detected in the video frames by the processor 102. The signal CTRL may be generated based on a type of object detected (e.g., a person, an animal, a vehicle, etc.). The signal CTRL may be generated in response to particular types of objects being detected in particular locations. The signal CTRL may be generated in response to user input in order to provide various parameters and/or settings to the processor 102 and/or the memory 150. The processor 102 may be configured to generate the signal CTRL in response to sensor fusion operations (e.g., aggregating information received from disparate sources). The processor 102 may be configured to generate the signal CTRL in response to results of liveness detection performed by the processor 102. The conditions for generating the signal CTRL may be varied according to the design criteria of a particular implementation.

The signal DIMAGES may comprise one or more of depth maps and/or disparity maps generated by the processor 102. The signal DIMAGES may be generated in response to 3D reconstruction performed on the monocular single-channel images. The signal DIMAGES may be generated in response to analysis of the captured video data and the structured light pattern.

The multi-step approach to activating and/or disabling the capture device 104 based on the output of the motion sensor 164 and/or any other power consuming features of the camera system 100 may be implemented to reduce a power consumption of the camera system 100 and extend an operational lifetime of the battery 152. A motion sensor of the sensors 164 may have a low drain on the battery 152 (e.g., less than 10 W). In an example, the motion sensor of the sensors 164 may be configured to remain on (e.g., always active) unless disabled in response to feedback from the processor/SoC 102. The video analytics performed by the processor/SoC 102 may have a relatively large drain on the battery 152 (e.g., greater than the motion sensor 164). In an example, the processor/SoC 102 may be in a low-power state (or power-down) until some motion is detected by the motion sensor of the sensors 164.

The camera system 100 may be configured to operate using various power states. For example, in the power-down state (e.g., a sleep state, a low-power state) the motion sensor of the sensors 164 and the processor/SoC 102 may be on and other components of the camera system 100 (e.g., the image capture device 104, the memory 150, the communications module 154, etc.) may be off. In another example, the camera system 100 may operate in an intermediate state. In the intermediate state, the image capture device 104 may be on and the memory 150 and/or the communications module 154 may be off. In yet another example, the camera system 100 may operate in a power-on (or high power) state. In the power-on state, the sensors 164, the processor/SoC 102, the capture device 104, the memory 150, and/or the communications module 154 may be on. The camera system 100 may consume some power from the battery 152 in the power-down state (e.g., a relatively small and/or minimal amount of power). The camera system 100 may consume more power from the battery 152 in the power-on state. The number of power states and/or the components of the camera system 100 that are on while the camera system 100 operates in each of the power states may be varied according to the design criteria of a particular implementation.

In some embodiments, the camera system 100 may be implemented as a system on chip (SoC). For example, the camera system 100 may be implemented as a printed circuit board comprising one or more components. The camera system 100 may be configured to perform intelligent video analysis on the video frames of the video. The camera system 100 may be configured to crop and/or enhance the video.

In some embodiments, the video frames may be some view (or derivative of some view) captured by the capture device 104. The pixel data signals may be enhanced by the processor 102 (e.g., color conversion, noise filtering, auto exposure, auto white balance, auto focus, etc.). In some embodiments, the video frames may provide a series of cropped and/or enhanced video frames that improve upon the view from the perspective of the camera system 100 (e.g., provides night vision, provides High Dynamic Range (HDR) imaging, provides more viewing area, highlights detected objects, provides additional data such as a numerical distance to detected objects, etc.) to enable the processor 102 to see the location better than a person would be capable of with human vision.

The encoded video frames may be processed locally. In one example, the encoded video may be stored locally by the memory 150 to enable the processor 102 to facilitate the computer vision analysis internally (e.g., without first uploading video frames to a cloud service). The processor 102 may be configured to select the video frames to be packetized as a video stream that may be transmitted over a network (e.g., a bandwidth limited network).

In some embodiments, the processor 102 may be configured to perform sensor fusion operations. The sensor fusion operations performed by the processor 102 may be configured to analyze information from multiple sources (e.g., the capture device 104, the IMU 106, the sensors 164 and the HID 166). By analyzing various data from disparate sources, the sensor fusion operations may be capable of making inferences about the data that may not be possible from one of the data sources alone. For example, the sensor fusion operations implemented by the processor 102 may analyze video data (e.g., mouth movements of people) as well as the speech patterns from directional audio. The disparate sources may be used to develop a model of a scenario to support decision making. For example, the processor 102 may be configured to compare the synchronization of the detected speech patterns with the mouth movements in the video frames to determine which person in a video frame is speaking. The sensor fusion operations may also provide time correlation, spatial correlation and/or reliability among the data being received.

In some embodiments, the processor 102 may implement convolutional neural network capabilities. The convolutional neural network capabilities may implement computer vision using deep learning techniques. The convolutional neural network capabilities may be configured to implement pattern and/or image recognition using a training process through multiple layers of feature-detection. The computer vision and/or convolutional neural network capabilities may be performed locally by the processor 102. In some embodiments, the processor 102 may receive training data and/or feature set information from an external source. For example, an external device (e.g., a cloud service) may have access to various sources of data to use as training data that may be unavailable to the camera system 100. However, the computer vision operations performed using the feature set may be performed using the computational resources of the processor 102 within the camera system 100.

A video pipeline of the processor 102 may be configured to locally perform de-warping, cropping, enhancements, rolling shutter corrections, stabilizing, downscaling, packetizing, compression, conversion, blending, synchronizing and/or other video operations. The video pipeline of the processor 102 may enable multi-stream support (e.g., generate multiple bitstreams in parallel, each comprising a different bitrate). In an example, the video pipeline of the processor 102 may implement an image signal processor (ISP) with a 320 MPixels/s input pixel rate. The architecture of the video pipeline of the processor 102 may enable the video operations to be performed on high resolution video and/or high bitrate video data in real-time and/or near real-time. The video pipeline of the processor 102 may enable computer vision processing on 4K resolution video data, stereo vision processing, object detection, 3D noise reduction, fisheye lens correction (e.g., real time 360-degree dewarping and lens distortion correction), oversampling and/or high dynamic range processing. In one example, the architecture of the video pipeline may enable 4K ultra high resolution with H.264 encoding at double real time speed (e.g., 60 fps), 4K ultra high resolution with H.265/HEVC at 30 fps and/or 4K AVC encoding (e.g., 4KP30 AVC and HEVC encoding with multi-stream support). The type of video operations and/or the type of video data operated on by the processor 102 may be varied according to the design criteria of a particular implementation.

In some embodiments, the camera sensor 180 may implement a high-resolution sensor. Using the high resolution sensor 180, the processor 102 may combine over-sampling of the image sensor 180 with digital zooming within a cropped area. The over-sampling and digital zooming may each be one of the video operations performed by the processor 102. The over-sampling and digital zooming may be implemented to deliver higher resolution images within the total size constraints of a cropped area. In some embodiments, the camera sensor 180 may implement a low-cost CMOS sensor. For example, the CMOS sensor 180 may be configured to capture 1080p resolution video.

In some embodiments, the lens 160 may implement a fisheye lens. One of the video operations implemented by the processor 102 may be a dewarping operation. The processor 102 may be configured to dewarp the video frames generated. The dewarping may be configured to reduce and/or remove acute distortion caused by the fisheye lens and/or other lens characteristics. For example, the dewarping may reduce and/or eliminate a bulging effect to provide a rectilinear image.

The processor 102 may be configured to crop (e.g., trim to) a region of interest from a full video frame (e.g., generate the region of interest video frames). The processor 102 may generate the video frames and select an area. In an example, cropping the region of interest may generate a second image. The cropped image (e.g., the region of interest video frame) may be smaller than the original video frame (e.g., the cropped image may be a portion of the captured video).

The area of interest may be dynamically adjusted based on the location of an audio source. For example, the detected audio source may be moving, and the location of the detected audio source may move as the video frames are captured. The processor 102 may update the selected region of interest coordinates and dynamically update the cropped section (e.g., directional microphones implemented as one or more of the sensors 164 may dynamically update the location based on the directional audio captured). The cropped section may correspond to the area of interest selected. As the area of interest changes, the cropped portion may change. For example, the selected coordinates for the area of interest may change from frame to frame, and the processor 102 may be configured to crop the selected region in each frame.

The processor 102 may be configured to over-sample the image sensor 180. The over-sampling of the image sensor 180 may result in a higher resolution image. The processor 102 may be configured to digitally zoom into an area of a video frame. For example, the processor 102 may digitally zoom into the cropped area of interest. For example, the processor 102 may establish the area of interest based on the directional audio, crop the area of interest, and then digitally zoom into the cropped region of interest video frame.

The dewarping operations performed by the processor 102 may adjust the visual content of the video data. The adjustments performed by the processor 102 may cause the visual content to appear natural (e.g., appear as seen by a person viewing the location corresponding to the field of view of the capture device 104). In an example, the dewarping may alter the video data to generate a rectilinear video frame (e.g., correct artifacts caused by the lens characteristics of the lens 160). The dewarping operations may be implemented to correct the distortion caused by the lens 160. The adjusted visual content may be generated to enable more accurate and/or reliable object detection.

Various features (e.g., dewarping, digitally zooming, cropping, etc.) may be implemented in the processor 102 as hardware modules. Implementing hardware modules may increase the video processing speed of the processor 102 (e.g., faster than a software implementation). The hardware implementation may enable the video to be processed while reducing an amount of delay. The hardware components used may be varied according to the design criteria of a particular implementation.

In some embodiments, the processor 102 may implement one or more coprocessors, cores and/or chiplets. For example, the processor 102 may implement one coprocessor configured as a general purpose processor and another coprocessor configured as a video processor. In some embodiments, the processor 102 may be a dedicated hardware module designed to perform particular tasks. In an example, the processor 102 may implement an AI accelerator. In another example, the processor 102 may implement a radar processor. In yet another example, the processor 102 may implement a dataflow vector processor. In some embodiments, other processors implemented by the apparatus 100 may be generic processors and/or video processors (e.g., a coprocessor that is physically a different chipset and/or silicon from the processor 102). In one example, the processor 102 may implement an x86-64 instruction set. In another example, the processor 102 may implement an ARM instruction set. In yet another example, the processor 102 may implement a RISC-V instruction set. The number of cores, coprocessors, the design optimization and/or the instruction set implemented by the processor 102 may be varied according to the design criteria of a particular implementation.

The processor 102 is shown comprising a number of blocks (or circuits) 190a-190n. The blocks 190a-190n may implement various hardware modules implemented by the processor 102. The hardware modules 190a-190n may be configured to provide various hardware components to implement a video processing pipeline, a radar signal processing pipeline and/or an AI processing pipeline. The circuits 190a-190n may be configured to receive the pixel data VIDEO, generate the video frames from the pixel data, perform various operations on the video frames (e.g., de-warping, rolling shutter correction, cropping, upscaling, image stabilization, 3D reconstruction, liveness detection, auto-exposure, etc.), prepare the video frames for communication to external hardware (e.g., encoding, packetizing, color correcting, etc.), parse feature sets, implement various operations for computer vision (e.g., object detection, segmentation, classification, etc.), etc. The hardware modules 190a-190n may be configured to implement various security features (e.g., secure boot, I/O virtualization, etc.). Various implementations of the processor 102 may not necessarily utilize all the features of the hardware modules 190a-190n. The features and/or functionality of the hardware modules 190a-190n may be varied according to the design criteria of a particular implementation. Details of the hardware modules 190a-190n may be described in association with U.S. patent application Ser. No. 16/831,549, filed on Apr. 16, 2020, U.S. patent application Ser. No. 16/288,922, filed on Feb. 28, 2019, U.S. patent application Ser. No. 15/593,493 (now U.S. Pat. No. 10,437,600), filed on May 12, 2017, U.S. patent application Ser. No. 15/931,942, filed on May 14, 2020, U.S. patent application Ser. No. 16/991,344, filed on Aug. 12, 2020, U.S. patent application Ser. No. 17/479,034, filed on Sep. 20, 2021, appropriate portions of which are hereby incorporated by reference in their entirety.

The hardware modules 190a-190n may be implemented as dedicated hardware modules. Implementing various functionality of the processor 102 using the dedicated hardware modules 190a-190n may enable the processor 102 to be highly optimized and/or customized to limit power consumption, reduce heat generation and/or increase processing speed compared to software implementations. The hardware modules 190a-190n may be customizable and/or programmable to implement multiple types of operations. Implementing the dedicated hardware modules 190a-190n may enable the hardware used to perform each type of calculation to be optimized for speed and/or efficiency. For example, the hardware modules 190a-190n may implement a number of relatively simple operations that are used frequently in computer vision operations that, together, may enable the computer vision operations to be performed in real-time. The video pipeline may be configured to recognize objects. Objects may be recognized by interpreting numerical and/or symbolic information to determine that the visual data represents a particular type of object and/or feature. For example, the number of pixels and/or the colors of the pixels of the video data may be used to recognize portions of the video data as objects. The hardware modules 190a-190n may enable computationally intensive operations (e.g., computer vision operations, video encoding, video transcoding, 3D reconstruction, depth map generation, liveness detection, etc.) to be performed locally by the camera system 100.

One of the hardware modules 190a-190n (e.g., 190a) may implement a scheduler circuit. The scheduler circuit 190a may be configured to store a directed acyclic graph (DAG). In an example, the scheduler circuit 190a may be configured to generate and store the directed acyclic graph in response to the feature set information received (e.g., loaded). The directed acyclic graph may define the video operations to perform for extracting the data from the video frames. For example, the directed acyclic graph may define various mathematical weighting (e.g., neural network weights and/or biases) to apply when performing computer vision operations to classify various groups of pixels as particular objects.

The scheduler circuit 190a may be configured to parse the acyclic graph to generate various operators. The operators may be scheduled by the scheduler circuit 190a in one or more of the other hardware modules 190a-190n. For example, one or more of the hardware modules 190a-190n may implement hardware engines configured to perform specific tasks (e.g., hardware engines designed to perform particular mathematical operations that are repeatedly used to perform computer vision operations). The scheduler circuit 190a may schedule the operators based on when the operators may be ready to be processed by the hardware engines 190a-190n.

The scheduler circuit 190a may time multiplex the tasks to the hardware modules 190a-190n based on the availability of the hardware modules 190a-190n to perform the work. The scheduler circuit 190a may parse the directed acyclic graph into one or more data flows. Each data flow may include one or more operators. Once the directed acyclic graph is parsed, the scheduler circuit 190a may allocate the data flows/operators to the hardware engines 190a-190n and send the relevant operator configuration information to start the operators.

Each directed acyclic graph binary representation may be an ordered traversal of a directed acyclic graph with descriptors and operators interleaved based on data dependencies. The descriptors generally provide registers that link data buffers to specific operands in dependent operators. In various embodiments, an operator may not appear in the directed acyclic graph representation until all dependent descriptors are declared for the operands.

One of the hardware modules 190a-190n (e.g., 190b) may implement an artificial neural network (ANN) module. The artificial neural network module may be implemented as a fully connected neural network or a convolutional neural network (CNN). In an example, fully connected networks are “structure agnostic” in that there are no special assumptions that need to be made about an input. A fully-connected neural network comprises a series of fully-connected layers that connect every neuron in one layer to every neuron in the other layer. In a fully-connected layer, for n inputs and m outputs, there are n*m weights. There is also a bias value for each output node, resulting in a total of (n+1)*m parameters. In an already-trained neural network, the (n+1)*m parameters have already been determined during a training process. An already-trained neural network generally comprises an architecture specification and the set of parameters (weights and biases) determined during the training process. In another example, CNN architectures may make explicit assumptions that the inputs are images to enable encoding particular properties into a model architecture. The CNN architecture may comprise a sequence of layers with each layer transforming one volume of activations to another through a differentiable function. In the example shown, the artificial neural network 190b may implement a convolutional neural network (CNN) module. The CNN module 190b may be configured to perform the computer vision operations on the video frames. The CNN module 190b may be configured to implement recognition of objects through multiple layers of feature detection. The CNN module 190b may be configured to calculate descriptors based on the feature detection performed. The descriptors may enable the processor 102 to determine a likelihood that pixels of the video frames correspond to particular objects (e.g., a particular make/model/year of a vehicle, identifying a person as a particular individual, detecting a type of animal, detecting characteristics of a face, etc.).

The CNN module 190b may be configured to implement convolutional neural network capabilities. The CNN module 190b may be configured to implement computer vision using deep learning techniques. The CNN module 190b may be configured to implement pattern and/or image recognition using a training process through multiple layers of feature-detection. The CNN module 190b may be configured to conduct inferences against a machine learning model.

The CNN module 190b may be configured to perform feature extraction and/or matching solely in hardware. Feature points typically represent interesting areas in the video frames (e.g., corners, edges, etc.). By tracking the feature points temporally, an estimate of ego-motion of the capturing platform or a motion model of observed objects in the scene may be generated. In order to track the feature points, a matching operation is generally incorporated by hardware in the CNN module 190b to find the most probable correspondences between feature points in a reference video frame and a target video frame. In a process to match pairs of reference and target feature points, each feature point may be represented by a descriptor (e.g., image patch, SIFT, BRIEF, ORB, FREAK, etc.). Implementing the CNN module 190b using dedicated hardware circuitry may enable calculating descriptor matching distances in real time.

The CNN module 190b may be configured to perform face detection, face recognition and/or liveness judgment. For example, face detection, face recognition and/or liveness judgment may be performed based on a trained neural network implemented by the CNN module 190b. In some embodiments, the CNN module 190b may be configured to generate the depth image from the structured light pattern. The CNN module 190b may be configured to perform various detection and/or recognition operations and/or perform 3D recognition operations.

The CNN module 190b may be a dedicated hardware module configured to perform feature detection of the video frames. The features detected by the CNN module 190b may be used to calculate descriptors. The CNN module 190b may determine a likelihood that pixels in the video frames belong to a particular object and/or objects in response to the descriptors. For example, using the descriptors, the CNN module 190b may determine a likelihood that pixels correspond to a particular object (e.g., a person, an item of furniture, a pet, a vehicle, etc.) and/or characteristics of the object (e.g., shape of eyes, distance between facial features, a hood of a vehicle, a body part, a license plate of a vehicle, a face of a person, clothing worn by a person, etc.). Implementing the CNN module 190b as a dedicated hardware module of the processor 102 may enable the apparatus 100 to perform the computer vision operations locally (e.g., on-chip) without relying on processing capabilities of a remote device (e.g., communicating data to a cloud computing service).

The computer vision operations performed by the CNN module 190b may be configured to perform the feature detection on the video frames in order to generate the descriptors. The CNN module 190b may perform the object detection to determine regions of the video frame that have a high likelihood of matching the particular object. In one example, the types of object(s) to match against (e.g., reference objects) may be customized using an open operand stack (enabling programmability of the processor 102 to implement various artificial neural networks defined by directed acyclic graphs each providing instructions for performing various types of object detection). The CNN module 190b may be configured to perform local masking to the region with the high likelihood of matching the particular object(s) to detect the object.

In some embodiments, the CNN module 190b may determine the position (e.g., 3D coordinates and/or location coordinates) of various features (e.g., the characteristics) of the detected objects. In one example, the location of the arms, legs, chest and/or eyes of a person may be determined using 3D coordinates. One location coordinate on a first axis for a vertical location of the body part in 3D space and another coordinate on a second axis for a horizontal location of the body part in 3D space may be stored. In some embodiments, the distance from the lens 160 may represent one coordinate (e.g., a location coordinate on a third axis) for a depth location of the body part in 3D space. Using the location of various body parts in 3D space, the processor 102 may determine body position, and/or body characteristics of detected people.

The CNN module 190b may be pre-trained (e.g., configured to perform computer vision to detect objects based on the training data received to train the CNN module 190b). For example, the results of training data (e.g., a machine learning model) may be pre-programmed and/or loaded into the processor 102. The CNN module 190b may conduct inferences against the machine learning model (e.g., to perform object detection). The training may comprise determining weight values for each layer of the neural network model. For example, weight values may be determined for each of the layers for feature extraction (e.g., a convolutional layer) and/or for classification (e.g., a fully connected layer). The weight values learned by the CNN module 190b may be varied according to the design criteria of a particular implementation.

The CNN module 190b may implement the feature extraction and/or object detection by performing convolution operations. The convolution operations may be hardware accelerated for fast (e.g., real-time) calculations that may be performed while consuming low power. In some embodiments, the convolution operations performed by the CNN module 190b may be utilized for performing the computer vision operations. In some embodiments, the convolution operations performed by the CNN module 190b may be utilized for any functions performed by the processor 102 that may involve calculating convolution operations (e.g., 3D reconstruction).

The convolution operation may comprise sliding a feature detection window along the layers while performing calculations (e.g., matrix operations). The feature detection window may apply a filter to pixels and/or extract features associated with each layer. The feature detection window may be applied to a pixel and a number of surrounding pixels. In an example, the layers may be represented as a matrix of values representing pixels and/or features of one of the layers and the filter applied by the feature detection window may be represented as a matrix. The convolution operation may apply a matrix multiplication between the region of the current layer covered by the feature detection window. The convolution operation may slide the feature detection window along regions of the layers to generate a result representing each region. The size of the region, the type of operations applied by the filters and/or the number of layers may be varied according to the design criteria of a particular implementation.

Using the convolution operations, the CNN module 190b may compute multiple features for pixels of an input image in each extraction step. For example, each of the layers may receive inputs from a set of features located in a small neighborhood (e.g., region) of the previous layer (e.g., a local receptive field). The convolution operations may extract elementary visual features (e.g., such as oriented edges, end-points, corners, etc.), which are then combined by higher layers. Since the feature extraction window operates on a pixel and nearby pixels (or sub-pixels), the results of the operation may have location invariance. The layers may comprise convolution layers, pooling layers, non-linear layers and/or fully connected layers. In an example, the convolution operations may learn to detect edges from raw pixels (e.g., a first layer), then use the feature from the previous layer (e.g., the detected edges) to detect shapes in a next layer and then use the shapes to detect higher-level features (e.g., facial features, pets, vehicles, components of a vehicle, furniture, etc.) in higher layers and the last layer may be a classifier that uses the higher level features.

The CNN module 190b may execute a data flow directed to feature extraction and matching, including two-stage detection, a warping operator, component operators that manipulate lists of components (e.g., components may be regions of a vector that share a common attribute and may be grouped together with a bounding box), a matrix inversion operator, a dot product operator, a convolution operator, conditional operators (e.g., multiplex and demultiplex), a remapping operator, a minimum-maximum-reduction operator, a pooling operator, a non-minimum, non-maximum suppression operator, a scanning-window based non-maximum suppression operator, a gather operator, a scatter operator, a statistics operator, a classifier operator, an integral image operator, comparison operators, indexing operators, a pattern matching operator, a feature extraction operator, a feature detection operator, a two-stage object detection operator, a score generating operator, a block reduction operator, and an upsample operator. The types of operations performed by the CNN module 190b to extract features from the training data may be varied according to the design criteria of a particular implementation.

One or more of the hardware modules 190a-190n may be configured to implement other types of AI models. In one example, the hardware modules 190a-190n may be configured to implement an image-to-text AI model and/or a video-to-text AI model. In another example, the hardware modules 190a-190n may be configured to implement a Large Language Model (LLM). Implementing the AI model(s) using the hardware modules 190a-190n may provide AI acceleration that may enable complex AI tasks to be performed on an edge device such as the edge devices 100a-100n.

One of the hardware modules 190a-190n may be configured to perform the virtual aperture imaging. One of the hardware modules 190a-190n may be configured to perform transformation operations (e.g., FFT, DCT, DFT, etc.). The number, type and/or operations performed by the hardware modules 190a-190n may be varied according to the design criteria of a particular implementation.

Each of the hardware modules 190a-190n may implement a processing resource (or hardware resource or hardware engine). The hardware engines 190a-190n may be operational to perform specific processing tasks. In some configurations, the hardware engines 190a-190n may operate in parallel and independent of each other. In other configurations, the hardware engines 190a-190n may operate collectively among each other to perform allocated tasks. One or more of the hardware engines 190a-190n may be homogeneous processing resources (all circuits 190a-190n may have the same capabilities) or heterogeneous processing resources (two or more circuits 190a-190n may have different capabilities).

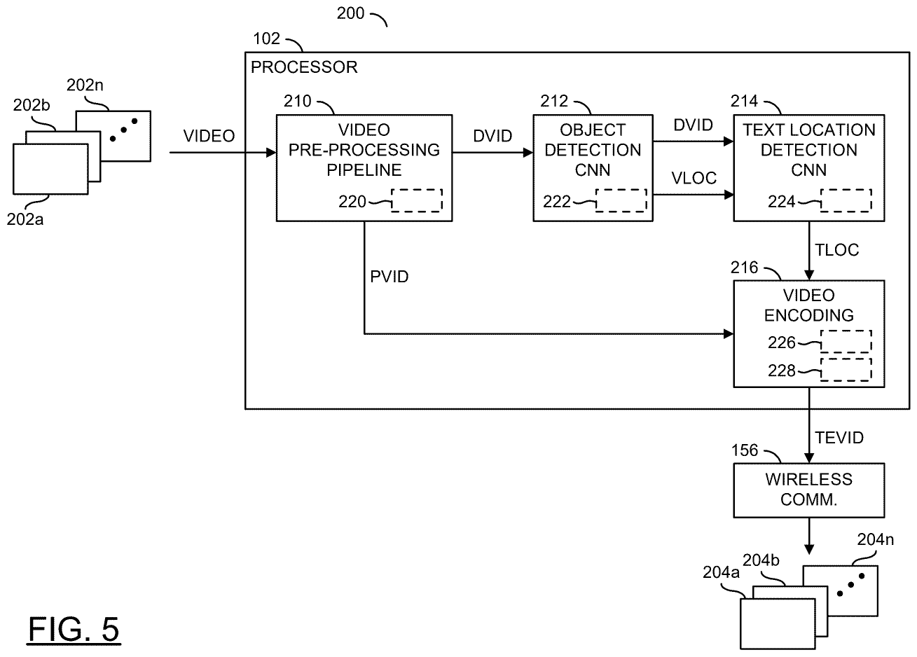

Referring to FIG. 5, a block diagram illustrating an AI adjusted region of interest encoding pipeline is shown. An AI adjusted region of interest encoding pipeline 200 is shown. The AI adjusted region of interest encoding pipeline 200 may be a representative example of an implementation on one of the camera systems 100a-100n. The AI adjusted region of interest encoding pipeline 200 may comprise the processor 102, the wireless communication device 156, input video frames 202a-202n and/or output video frames 204a-204n. The AI adjusted region of interest encoding pipeline 200 may comprise other components (not shown). The number, type and/or arrangement of the components of the AI adjusted region of interest encoding pipeline 200 may be varied according to the design criteria of a particular implementation.

The input video frames 202a-202n may comprise pixel data arranged as video frames. The input video frames 202a-202n may comprise raw (or uncompressed) video frames. For example, the input video frames 202a-202n may be uncompressed video frames in a YUV format. The uncompressed video frames 202a-202n may be generated by the CMOS image sensor 180. The uncompressed video frames 202a-202n may be received by the interface of the processor 102. For example, the CMOS image sensor 180 may present the signal VIDEO to the interface of the processor 102 comprising the uncompressed video frames 202a-202n. Each of the uncompressed video frames 202a-202n may comprise visual content that may or may not comprise text.

The output video frames 204a-204n may comprise pixel data arranged as video frames. The output video frames 204a-204n may comprise encoded video frames. For example, the output video frames 204a-204n may be generated in response to the AI adjusted ROI encoding performed by the processor 102 on the uncompressed video frames 202a-202n. For example, each of the encoded video frames 204a-204n may correspond to a respective one of the uncompressed video frames 202a-202n.

The encoded video frames 204a-204n may comprise fewer bits of data compared to the uncompressed video frames 202a-202n. For example, storing the encoded video frames 204a-204n may use less storage capacity than storing the uncompressed video frames 202a-202n and/or communicating the encoded video frames 204a-204n may use less bandwidth than communicating the uncompressed video frames 202a-202n. Generally, the video quality of the uncompressed video frames 202a-202n may be higher than for the encoded video frames 204a-204n. For example, the AI adjusted ROI encoding operations performed by the processor 102 may preserve as much of the video quality of the uncompressed video frames 202a-202n as possible, while reducing the number of bits used to represent the same visual content. Compression used to generate the encoded video frames 204a-204n may inherently reduce an image quality compared to the uncompressed video frames 202a-202n. Encoding the uncompressed video frames 202a-202n may provide a trade-off between video quality and bitrate (e.g., file size). For example, a higher compression ratio may result in lower video quality of the encoded video frames 204a-204n. The AI adjusted ROI encoding provided by the processor 102 may generate the encoded video frames 204a-204n with a reduced bitrate compared to the uncompressed video frames 202a-202n, while preserving text clarity in the video data.

The wireless communications module 156 may communicate the encoded video frames 204a-204n. A wireless communication protocol and/or a wireless communication channel available to the wireless communication module 156 may be bandwidth restricted. For example, communicating the uncompressed video frames 202a-202n via the wireless communication module 156 may not be feasible and/or may oversaturate the available bandwidth in the communication channel. The reduction in bitrate provided by the encoded video frames 204a-204n may enable the wireless communication module 156 to communicate the encoded video frames 204a-204n (e.g., communicate within the bandwidth constraints of the communication channel).

In some embodiments, the wireless communication of the encoded video frames 204a-204n may be presented to a cloud storage service and/or a remote computing device. In one example, the remote computing device may have limited storage capacity. In another example, the cloud storage service may provide mass storage of data for a fee, with higher fees imposed for higher amounts of data stored in the cloud storage service. In some embodiments, the encoded video frames 204a-204n may be stored locally on the respective camera systems 100a-100n. For example, the camera systems 100a-100n may implement a local storage device (e.g., a microSD card) with limited storage capacity (e.g., providing loop recording where the newest data may overwrite the oldest data when the storage device is full). Storing the encoded video frames 204a-204n at a particular average bitrate (e.g., a lower bitrate than the uncompressed video frames 202a-202n) may enable more data to be stored in a particular storage medium. The amount of storage capacity available and/or the cost associated with storing the encoded video frames 204a-204n may be varied according to the design criteria of a particular implementation.

The processor 102 may comprise a block (or circuit) 210, a block (or circuit) 212, a block (or circuit) 214 and/or a block (or circuit) 216. The circuit 210 may implement a video pre-processing pipeline. The circuit 212 may implement an object (or vehicle) detection CNN. The circuit 214 may implement a text location detection CNN. The circuit 216 may implement a video encoding module. Each of the circuits 210-216 may be implemented as a combination of one or more of the hardware modules 190a-190n shown in association with FIG. 4. The processor 102 may comprise other components (not shown). The number, type and/or arrangement of the components of the processor 102 used to implement the AI adjusted ROI encoding may be varied according to the design criteria of a particular implementation.

The video pre-processing pipeline 210 may be configured to receive the signal VIDEO. The video pre-processing pipeline 210 may be configured to generate a signal (e.g., PVID) and/or a signal (e.g., DVID) in response to the signal VIDEO. The signal PVID may comprise pre-processed video data. The video pre-processing pipeline 210 may be configured to perform various pre-processing operations on the uncompressed video frames 202a-202n. The video pre-processing pipeline 210 may be configured to present the signal PVID to the video encoding module 216. In some embodiments, the video pre-processing pipeline 210 may be configured to present the signal PVID to the memory 150 (e.g., for storage). In some embodiments, the video pre-processing pipeline 210 may be configured to communicate the signal PVID to other components of the processor 102 for other types of video processing.

The video pre-processing pipeline 210 may be configured to receive the pixel data in the signal VIDEO. The video pre-processing pipeline 210 may be configured to process the pixel data arranged as video frames. The pre-processing performed by the pre-processing pipeline 210 may prepare the video data using various pre-processing operations (e.g., motion detection, cropping, auto-balance, cropping, stabilization, upscaling, downscaling, dewarping, formatting for an output device, color space conversion, noise reduction, etc.) that may be used for various types of analysis (e.g., object detection, behavior detection, depth analysis, object tracking, etc.). The video pre-processing pipeline 210 may be configured to prepare the raw pixel data in the uncompressed video frames 202a-202n for further analysis by the neural networks implemented by the AI adjusted region of interest encoding pipeline 200. The pre-processed video frames in the signal PVID may comprise a full-sized version of the input video frames 202a-202n.

The video pre-processing pipeline 210 may comprise a block (or circuit) 220. The circuit 220 may implement a downscaling module. The downscaling module 220 may be configured to generate the signal DVID in response to the signal VIDEO. In some embodiments, the signal DVID may comprise a downscaled version of the input video frames 202a-202n. In some embodiments, the signal DVID may comprise a cropped version of the input video frames 202a-202n. The downscaling module 220 may be configured to generate video frames that may be a smaller version of the input video frames 202a-202n. For example, the video data presented in the signal DVID may comprise a lower resolution than the resolution of the input video frames 202a-202n and/or the pre-processed video frames in the signal PVID. In one example, the downscaling module 220 may be configured to perform downscaling operations (e.g., reduce a resolution of the input video frames 202a-202n by scaling the video data to a proportionally smaller size). In another example, the downscaling module 220 may be configured to perform cropping operations (e.g., reduce a resolution of the input video frames 202a-202n by removing a portion of the input video frames 202a-202n). For example, video data near a top of the input video frames 202a-202n may be cropped out since vehicles may be less likely to appear near a top of the video frames (e.g., in the sky). The type of operations performed to reduce the resolution for the video data in the signal DVID may be varied according to the design criteria of a particular implementation.

The signal DVID may be presented to the object detection CNN 212. For example, performing video detection operations (e.g., vehicle detection, sign detection, license plate detection, text detection) on video data in a lower resolution than the input video frames 202a-202n may enable particular objects to still be detected, while reducing a number of computations performed. For example, performing the object detection on video data with a smaller size than the full-size input video frames 202a-202n may consume fewer resources, reduce power consumption and/or reduce a computation time. Data coordinates determined in response to object detection may be mapped to the coordinates in the full-size video frames (e.g., the input video frames 202a-202n and/or the pre-processed video frames in the signal PVID).

The object detection CNN 212 may implement a lightweight neural network. The object detection CNN 212 may be configured to receive the signal DVID. In some embodiments, the object detection CNN 212 may receive the signal PVID (e.g., the object detection operations may be performed on the full-size pre-processed video frames). The object detection CNN 212 may comprise a block (or circuit) 222. The circuit 222 may implement a neural network model. The object detection CNN 212 may be configured to implement the neural network model 222 trained to recognize locations and/or sizes of vehicles in the uncompressed, pre-processed and/or downscaled video frames. For example, the neural network model 222 implemented by the object detection CNN 212 may be trained on training data that may be labeled to provide an indication of a vehicle location in response to video data. In some embodiments, the neural network model 222 may be trained to detect the location of road signs. The object detection CNN 212 may be configured to perform a whole frame search for the vehicles. In some embodiments, the object detection CNN 212 may be configured to detect vehicles in particular regions of the video data (e.g., vehicle searching may be limited to road regions in the video frame). The object detection CNN 212 may generate bounding box locations of vehicles detected in the uncompressed video frames 202a-202n. The object detection CNN 212 may be configured to generate a signal (e.g., VLOC) in response to the signal DVID. The signal VLOC may be presented to the text location detection CNN 214. The signal DVID may be passed through to the text location detection CNN 214.

The signal VLOC may comprise vehicle location data. In one example, the vehicle location data may comprise one or more coordinates of the video frame along with height and width data for each detected vehicle. In another example, the vehicle location data may comprise four corners of each bounding box. In yet another example, the vehicle location data may comprise a list of encoding blocks that correspond to an area of each detected vehicle. The vehicle location data may provide bounding box information for each of the vehicles detected in one or more of the video frames provided by the signal DVID. For example, after a vehicle location (or sign location) is detected, the bounding box parameters (e.g., presented in the signal VLOC) and the downscaled full video frame (e.g., presented in the signal DVID) may be sent to text location detection CNN 214. The format of the vehicle location data may be varied according to the design criteria of a particular implementation.

The text location detection CNN 214 may implement a lightweight neural network. The text location detection CNN 214 may be configured to receive the signal VLOC and/or the signal DVID. The text location detection CNN 214 may comprise a block (or circuit) 224. The circuit 224 may implement a neural network model. The text location detection CNN 214 may be configured to implement the neural network model 224 trained to recognize locations of license plates within a vehicle bounding box in the uncompressed, pre-processed and/or downscaled video frames. For example, the neural network model 224 implemented by the text location detection CNN 214 may be trained on training data that may be labeled to provide an indication of a license plate location and/or license plate size in response to video data and/or bounding box information for vehicles. In some embodiments, the neural network model 224 may be trained to detect text on road signs.

The text location detection CNN 214 may be configured to limit a search region to the bounding box locations of vehicles and/or signs) in the video frames. For example, the text location detection CNN 214 may be configured to detect license plates in less than the entire video frame. Limiting the license plate detection search to the locations of the vehicle bounding boxes may limit the amount of computational resources used (e.g., less data to analyze than the entire video frame) and/or prevent false positives (e.g., avoid detecting objects that appear similar to license plates and/or decorative license plates that may be mounted to a wall). The text location detection CNN 214 may generate region(s) of interest that correspond to the location of the license plates of vehicles detected in the uncompressed video frames 202a-202n. The text location detection CNN 214 may be configured to generate a signal (e.g., TLOC) in response to the signal VLOC. The signal TLOC may be presented to the video encoding module 216.

The signal TLOC may comprise region of interest data. In one example, the region of interest data may comprise one or more coordinates of the video frame along with height and width data for each detected license plate. In another example, the region of interest data may comprise four corners of each license plate bounding box. In yet another example, the region of interest data may comprise a list of encoding blocks that correspond to an area of each detected license plate. The region of interest data may provide bounding box information for the license plate detected in one or more of the vehicle bounding boxes provided by the signal VLOC. The format of the vehicle location data may be varied according to the design criteria of a particular implementation.

In the example AI adjusted region of interest encoding pipeline 200 embodiment shown, two light weight CNNs may be implemented for license plate detection. In some embodiments, a single CNN may be implemented to perform both the vehicle detection and the license plate detection. In some embodiments, other types of vehicle and/or license plate detection may be performed (e.g., feature extraction and/or object detection) that do not implement a CNN. The type of video analysis performed by the processor 102 to detect the vehicle bounding boxes and/or the license plate ROIs may be varied according to the design criteria of a particular implementation.

The video encoding module 216 may be configured to perform video compression and/or encoding operations. The video encoding module 216 may be configured to receive the signal TLOC and/or the signal PVID. The video encoding module 216 may be configured to receive the pixel data arranged as video frames as the video data is generated in real-time. The signal TLOC may comprise the coordinates of the text location (e.g., the coordinates of the license plate). The video encoding module 216 may be configured to map the coordinates of the license plate and/or text location to the full-size video data in the signal PVID. The full-size video data of the pre-processed video frames in the signal PVID may be used for the video encoding. The video encoding module 216 may be configured to generate a signal (e.g., TEVID) in response to the signal TLOC and the signal PVID. The signal TEVID may comprise the encoded video frames 204a-204n. The signal TEVID may be presented to the wireless communications module 156. In some embodiments, the signal TEVID may be stored locally (e.g., by the memory 150).

The video encoding module 216 may be configured to compress the video data. In one example, the compression performed by the video encoding module 216 may be an H.264 encoding. In another example, the compression performed by the video encoding module 216 may be an H.265 encoding. In yet another example, the compression performed by the video encoding module 216 may be an AV1 encoding. For example, the video encoding module 216 may be capable of generating 4K ultra high resolution with H.264 encoding at double real time speed (e.g., 60 fps). In another example, the video encoding module 216 may be capable of generating a 4K ultra high resolution with H.265/HEVC at 60 fps and/or 4K AVC encoding (e.g., 4KP30 AVC and HEVC encoding with multi-stream support). The video encoding module 216 may be configured to convert a raw, uncompressed video stream into a specific digital format suitable for storage, transmission, and/or playback. The video encoding module 216 may be configured to apply a video codec (e.g., H.264, H.265, VP9, AV1, etc.) to compress the video data. The video encoding module 216 may be configured to multiplex the compressed video with compressed audio into a container format (e.g. MP4, MKV). The video encoding module 216 may be configured to add metadata to the video data (e.g., camera ID, camera make/model, GPS data, resolution, bitrate, framerate, etc.). The encoding operations performed by the video encoding module 216 may be varied according to the design criteria of a particular implementation.

For the bandwidth limited and/or resource constrained operations of the AI adjusted region of interest encoding pipeline 200, the video encoding module 216 may be configured to implement multiple video encoding parameters. In one example, the video encoding module 216 may be configured to implement at least two sets of video encoding parameters 226-228. One set of video encoding parameters 226 (e.g., general encoding parameters) may be selected for locations of the uncompressed video frames 202a-202n that do not comprise the ROIs (e.g., license plate text and/or other types of text such as road sign text). For example, in the uncompressed video frames 202a-202n with no vehicles and/or license plates detected, the entire uncompressed video frame may be encoded with the same set of the general video encoding parameters 226. The general encoding parameters 226 may be selected to achieve a target average bitrate for the encoded video frames 204a-204n. For example, the target average bitrate may be approximately the available bandwidth for the communication channel used by the wireless communication device 156. A second set of encoding parameters 228 (e.g., text clarity parameters) may be selected for locations of the uncompressed video frames 202a-202n that do comprise the ROIs. For example, in the uncompressed video frames 202a-202n with vehicles and/or license plates detected, the ROIs may be encoded with the text clarity parameters 228 and the regions of the uncompressed video frames 202a-202n outside of the ROIs may be encoded with the general encoding parameters 226 (or other lower quality video parameters).

The video encoding module 216 may be configured to determine an offset value to apply to the general encoding parameters 226. The offset value may be a negative offset value. The negative offset value may be used to select the text clarity parameters 228. For example, lower QP may result in higher quality video and/or text clarity. In some embodiments, the video encoding module 216 may be configured to add a positive offset value to the general encoding parameters 226. Since the negative offset value for the text clarity parameters 228 may increase a bitrate of the encoded video frames 204a-204n, the positive offset applied to the general encoding parameters 226 may compensate by lowering the bitrate to achieve the original target bitrate (e.g., the bitrate when no text is detected). Generally, since the ROI(s) for the license plate location may comprise a relatively small portion of the video frames, the amount of the positive offset to the general encoding parameters 226 may be less than the negative offset applied for selecting the text clarity parameters 228.

The signal TLOC may comprise data for the ROI. The ROI may be used to determine the encoding parameters (e.g., QP in the macro block for the general encoding parameters 226 and/or the text clarity parameters 228). For example, the QP may be a type of weight. The QP may be encoding tools that may influence how the video encoding module 216 allocates the H264/H265 encoded bits to the encoded video frame in the signal TEVID. In some embodiments, the encoding parameters may be determined in response to a combination of the overall size of the ROI(s), the distance of the ROI(s) from the image sensor 180, a relative speed of the detected ROI(s) with respect to the image sensor 180, etc.

In some embodiments, the object detection CNN 212 may determine a distance of the detected vehicles from the image sensor 180. The distance may be determined based on the relative size of the vehicles detected. The text location detection CNN 214 may be configured to apply a filter to the license plate detection locations. The filter may remove license plates determined to be too far away to provide clear text. For example, license plates that may be considered too far away may already have illegible test in the source uncompressed video frames 202a-202n. Of the remaining license plates ROIs (e.g., the license plates within the pre-determined distance for text clarity), the video encoding module 216 may select the QP independently for each of the license plates. For example, the text clarity encoding parameters 228 may be adaptively selected for each license plate based on distance. Generally, text located farther away may be more difficult to read and/or may be more negatively impacted by encoding. For example, larger negative offset values may be selected for the text clarity encoding parameters 228 for license plates that are farther away and smaller negative offset value may be selected for the text clarity encoding parameters 228 for license plates that are closer to the image sensor 180. Multiple sets of text clarity encoding parameters 228 may be determined to provide text clarity for multiple license plates detected in the same video frame. The amount of negative offset applied for each distance may be varied according to the design criteria of a particular implementation.

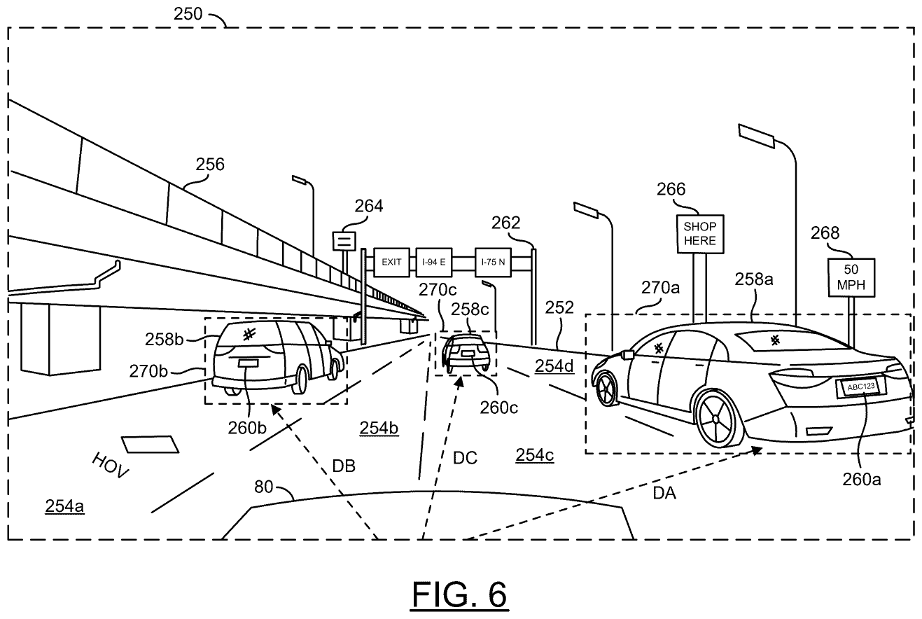

Referring to FIG. 6, a diagram illustrating computer vision operations performed on an example video frame to detect vehicle bounding box locations is shown. An example video frame 250 is shown. The example video frame 250 may comprise pixel data captured by the capture device 104. In one example, the video frame 250 may be provided to the processor 102 as the signal VIDEO. In another example, the video frame 250 may be generated by the processor 102 in response to the pixel data provided in the signal VIDEO. The pixel data of the video frame 250 received by the processor 102 may correspond to one of the uncompressed video frames 202a-202n. In some embodiments, the video frame 250 may be a pre-processed video frame provided by the signal PVID. In some embodiments, the video frame 240 may be a downscaled video frame provided by the signal DVID. In some embodiments, the example video frame 250 may be presented as human viewable video output to one or more video displays. In some embodiments, the example video frame 250 may be utilized internal to the processor 102 to perform the computer vision operations. For example, the video frame 250 may be analyzed by the object detection CNN 212.

The example video frame 250 may comprise a view of a roadway 252. In an example, the example video frame 250 may be captured by one of the camera systems 100a-100n mounted to the vehicle 80 (e.g., a view provided by the all-around view 92a-92d). A portion of the vehicle 80 driving on the road 252 is shown in the video frame 250. The roadway 252 may comprise lanes 254a-254d. An overpass 256 is shown above the roadway 252. For example, the external environment 70 shown in the video frame 250 may comprise a highway system. Vehicles 258a-258c are shown. The vehicles 258a-258c may be ahead of the vehicle 80 on the roadway 252. The vehicle 258a may be in the lane 254d, the vehicle 258a may be in the lane 254d and the vehicle 258c may be in the lane 254c. Each of the vehicles 258a-258c may have respective license plates 260a-260c. In the example shown, the license plate 260a may comprise the characters ‘ABC123’. Signs 262-268 are shown. The sign 262 may be overhead directional road signs, the sign 264 may be a distant sign, the sign 266 may be an advertisement, and the sign 268 may be a speed limit road sign.

Dotted shapes 270a-270c are shown in the video frame 250. The dotted shapes 270a-270c may represent the detection of an object/subject by the computer vision operations performed by the processor 102. The dotted shapes 270a-270c may comprise the pixel data corresponding to an object detected by the AI adjusted region of interest encoding pipeline 200, the neural network model 190b and/or a video-to-text AI model. For the AI adjusted region of interest encoding pipeline 200, the dotted shapes 270a-270c may correspond to objects detected by the object detection CNN 212. In the example shown, the dotted shape 270a may correspond to the vehicle 258a, the dotted shape 270b may correspond to the vehicle 258b and the dotted shape 270c may correspond to the vehicle 258c. For illustrative purposes, only the dotted shapes 270a-270c are shown. However, other types of objects (e.g., the signs 262-268, pedestrians, bicycles, lane dividers, etc.) may be detected as an object. In some embodiments, various other types of objects may be detected in response to animal detection, household object detection, interior object detection, person detection, vehicle detection, roadway detection, sky region detection, obstacle detection and/or exterior object detection (e.g., one or more of the neural network 190b, a video-to-text AI model, the object detection CNN 212 and/or the text location detection CNN 214 may comprise libraries configured to detect people, vehicles, objects, animals, etc.). In the example shown, the libraries implemented and/or the training data used to train the AI models (e.g., the neural network model 222 and/or the neural network model 224) may be configured to enable detection and/or description of objects that may comprise text (e.g., vehicles). For example, the libraries implemented may be configured to detect sedans, minivans, trucks, SUVs, motorcycles, delivery vans, transport trucks, longhaul vehicles, construction vehicles, etc. The dotted shapes 270a-270c are shown for illustrative purposes. In an example, the dotted shapes 270a-270c may be visual representations of the object detection (e.g., the dotted shapes 270a-270c may not appear on an output video frame in the signal VIDOUT and/or the video TEVID). In another example, the dotted shapes 270a-270c may be bounding boxes generated by the processor 102 displayed on the output video frames to indicate that an object has been detected (e.g., the dotted shapes 270a-270c may be displayed in a debug mode of operation).

The computer vision operations, vehicle detection analysis, the license plate detection and/or the video-to-text (or sensor-fusion-to-text) operations may be configured to detect characteristics of the detected objects, behavior of the objects detected, a movement direction of the objects detected, a context of the objects detected and/or a liveness of the objects detected. The characteristics of the objects may comprise a height, length, width, slope, an arc length, a color, a color temperature, an amount of light emitted, detected text on the object, a path of movement, a speed of movement, a direction of movement, a proximity to other objects, etc. The characteristics of the detected object may comprise a status of the object (e.g., opened, closed, on, off, etc.). The characteristics of the detected object may comprise a distance measurement from the lens 160 to the detected object. The behavior and/or liveness may be determined in response to the type of object and/or the characteristics of the objects detected. While one example video frame 250 is shown, the behavior, movement direction (e.g., trajectory) and/or liveness of an object may be determined by analyzing a sequence of video frames captured over time. For example, a path of movement and/or speed of movement characteristic may be used to determine that an object classified as a person may be walking or running. The speed and/or direction of movement may be used to track a location of object over multiple video frames and/or estimate a location in between video frames and/or in between a number of video frame intervals. The types of characteristics and/or behaviors detected may be varied according to the design criteria of a particular implementation.

In the example shown, the bounding boxes 270a-270c may be regions of interest of a subset of the objects in the video frame 250. The bounding boxes 270a-270c are shown as representative examples of various objects but, generally, many more objects may be detected (e.g., dents, scratches, animals, other people, etc.). In an example, the settings (e.g., the feature set) for the processor 102 (e.g., the computer vision AI neural network model implemented by the neural network 190b, a video-to-text AI model, the object detection CNN 212 and/or the text location detection CNN 214) may define objects of interest to be vehicle, pets, people, storage objects, sporting equipment, tools, supplies, lens obstructions etc. For example, doorways, ceilings, and/or stairs may not be objects of interest for a feature set defined to detect objects in or near a vehicle. In the example shown, the bounding boxes 270a-270c are shown having a cubic (or rectangular) shape. In some embodiments, the shape of the bounding boxes 270a-270c that correspond to the objects of interest detected may be formed to follow the shape of the body of the vehicles detected and/or the shape of the various objects detected (e.g., an irregular shape that follows the curves and/or the body shape of the detected objects).

The processor 102, the CNN module 190b and/or the video-to-text AI model may be configured to implement region, vehicle, road sign, animal, lens obstruction, object and/or face detection techniques. In some embodiments, other types of subjects as objects of interest may be detected (e.g., passengers, pedestrians, street signs, etc.). The computer vision techniques and/or the video-to-text techniques may be configured to detect the regions of interest (ROIs) of the detected objects 270a-270c and/or generate the information about the detected objects 270a-270c and/or the context of the scene generally. For example, the bounding boxes 270a-270c may be a visual representation of the ROIs detected. The computer vision technique may be looped (e.g., to iteratively perform object/subject detection throughout the example video frame 250) in order to determine if any objects of interest (e.g., as defined by the feature set) are within the field of view of the lens 160 and/or the image sensor 180.

While only the objects 270a-270c are shown as objects of interest (e.g., the vehicles 258a-258c), the computer vision operations and/or the video-to-text operations performed by the processor 102, neural network 190b, a video-to-text AI model, the object detection CNN 212 and/or the text location detection CNN 214 may be configured to detect background objects and/or other types of objects. The background objects may be detected for other computer vision purposes (e.g., training data, labeling, depth detection, etc.). The type(s) of subjects identified as the objects of interest 270a-270c may be varied according to the design criteria of a particular implementation. Details of computer vision, video-to-text operations and/or sensor-fusion-to-text operations may be described in association with U.S. patent application Ser. No. 18/583,298, filed on Feb. 11, 2024, U.S. patent application Ser. No. 18/621,504, filed on Mar. 29, 2024, U.S. patent application Ser. No. 18/657,588, filed on May 7, 2024 and/or U.S. patent application Ser. No. 18/657,492, filed on May 7, 2024, appropriate portions of which are incorporated by reference.

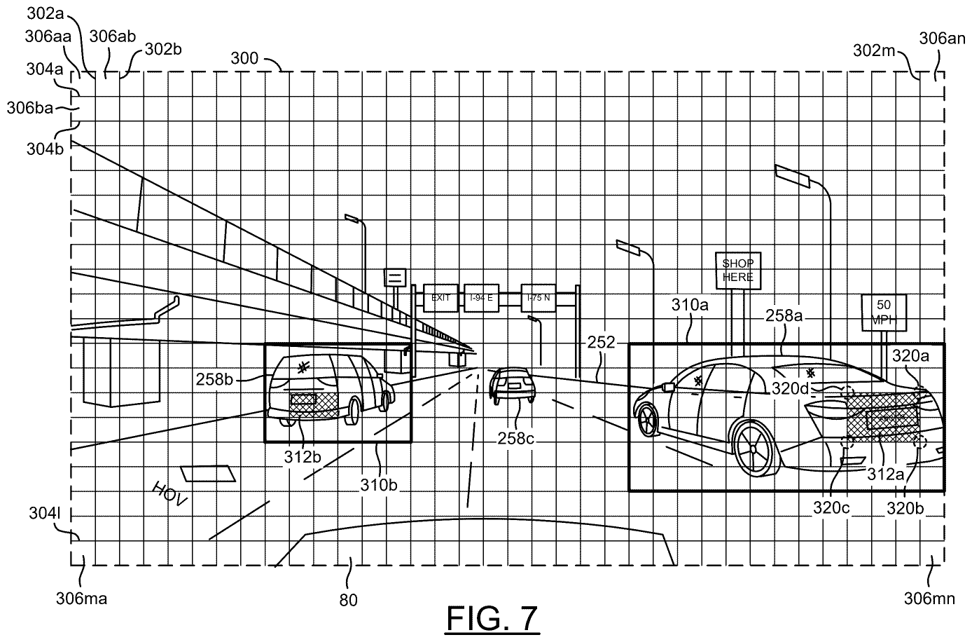

The bounding boxes 270a-270c may represent a location of the vehicles 258a-258c in the video frame 250. For example, the bounding boxes 270a-270c may be determined by the object detection CNN 212. The bounding boxes 270a-270c may be provided to the text location detection CNN 214 in the signal VLOC. The text location detection CNN 214 may use the vehicle locations of the bounding boxes 270a-270c to detect the location of the license plates 260a-260c (to be described in association with FIG. 7). In the example shown, the vehicle 258a may be a sedan, the vehicle 258b may be a minivan and the vehicle 258c may be a sedan. The types of the vehicles 258a-258c detected for the bounding boxes 270a-270c may be representative examples. Other types of vehicles may be detected (e.g., trucks, SUVs, hatchbacks, crossovers, coupes, sports cars, station wagons, convertibles, dump trucks, transport trucks, concrete mixers, garbage trucks, ambulances, fire trucks, flatbed trucks, agricultural vehicles, etc.). The types of vehicles detected by the object detection CNN 212 may be varied according to the design criteria of a particular implementation.

Dashed arrows (e.g., DA-DC) are shown. The dashed arrows DA-DC may correspond to a respective one of the bounding boxes 270a-270c. The dashed arrows DA-DC may represent distances of the bounding boxes 270a-270c from the image sensor 180. The object detection CNN 212 may be configured to determine a distance from each of the objects detected from the image sensor 180. In the example shown, the distance DA may be a distance calculated from the image sensor 180 to the bounding box 270a (e.g., the vehicle location for the vehicle 258a), the distance DB may be a distance calculated from the image sensor 180 to the bounding box 270b (e.g., the vehicle location for the vehicle 258b), and the distance DC may be a distance calculated from the image sensor 180 to the bounding box 270c (e.g., the vehicle location for the vehicle 258c).

The encoding module 216 may be configured to select different QP settings for each of the license plates and/or text for the objects detected. In one example, the QP settings may be selected based on a size of the license plates and/or a size of the text. Generally, the sizes of the vehicles 258a-258c may be similar. For example, other than motorcycles, most vehicles may have license plates of the same size. Since the vehicle sizes may be similar, the size of each of the license plates may be generally proportional to the size of the bounding boxes 270a-270c. The size of the bounding boxes 270a-270c may be generally proportional to the distances DA-DC. For example, the distances DA-DC may be used by the object detection CNN 212, the text location detection CNN 214 and/or the video encoding module 216 to determine the QP settings and/or which objects to skip for the text enhancement.

Referring to FIG. 7, a diagram illustrating vehicle license plate detection at a block level of a video frame is shown. An example license plate detection 300 is shown. The license plate detection 300 may comprise an illustrative example of the video frame 250 as described in association with FIG. 6. For example, the ego vehicle 80, the roadway 252 and the vehicles 258a-258c are shown. The license plate detection 300 may represent the determination of the ROIs performed by the text location detection CNN 214 in response to the signal VLOC and the uncompressed video frames 202a-202n.

The license plate detection 300 may comprise a number of vertical lines 302a-302m and a number of horizontal lines 304a-304l. The vertical lines 302a-302m and the horizontal lines 304a-304l may form a grid pattern. The grid pattern may comprise a number of blocks 306aa-306mn. The grid pattern 306aa-306mn may represent the encoding block locations for the uncompressed video frames 202a-202n. The number of the encoding blocks 306aa-306mn for each of the uncompressed video frames 202a-202n may depend on the size (e.g., resolution) of the uncompressed video frames (or the downscaled video frames in the signal DVID) and/or the size of the encoding blocks 306aa-306mn. In some embodiments, the size of the encoding blocks 306 aa-306mn may be a variable value with a range from 4×4 pixels to 64×64 pixels. In one example, the encoding blocks 306aa-306mn may each be a CTU (coding tree unit) with a size of 16×16 pixels for the H.265 encoding standard. Generally, the encoding blocks 306aa-306mn may be a rectangular shape with a width/height in pixels having a power of 2. For example, because of the rectangular shape of the encoding blocks 306aa-306mn the processor 102 may be configured to map (e.g., by rounding up) any bounding box (e.g., license plate parameter) to a rectangle of the encoding blocks 306aa-306mn in either H.264 or H.265. The size of each of the encoding blocks 306aa-306mn may be varied according to the design criteria of a particular implementation.

Vehicle locations 310a-310b are shown. The vehicle locations 310a-310b may correspond with the bounding boxes 270a-270b shown in association with FIG. 6. For example, the vehicle location 310a may correspond with the vehicle 258a and the vehicle location 310b may correspond with the vehicle 258b. The vehicle 258c (detected with the bounding box 270c shown in association with FIG. 6) may not have a corresponding vehicle location in the license plate detection 300. For example, the processor 102, the object detection CNN 212 and/or the text location detection CNN 214 may have filtered out the vehicle 258c based on the distance DC. For example, the license plate 260c may have been determined to be too far away to enable legible text (e.g., the text may have already been illegible in the source uncompressed video frame and the adjustment of the encoding parameters may provide no benefit).

Shaded regions 312a-312b are shown. The shaded regions 312a-312b may correspond to a location of the license plates 260a-260b within the respective vehicle locations 310a-310b. The shaded regions 312a-312b may represent a detected license plate ROI. The license plate ROIs 312a-312b may be detected by the text location detection CNN 214 in response to the signal VLOC. The signal TLOC may comprise the license plate ROIs 312a-312b. While two of the license plate ROIs 312a-312b are shown in the example license plate detection 300, the number of license plate ROIs detected may vary based on the number of vehicles detected and/or the distances to the vehicles in the uncompressed video frames 202a-202n.

The license plate ROIs 312a-312b may comprise a total encoding block area (e.g., a macroblock/CTB area). The license plate ROIs 312a-312b may comprise one or more of the encoding blocks 306aa-306mn. For example, the license plate ROIs 312a-312b may correspond to full encoding blocks 306aa-306mn. A full encoding block may be selected for the license plate ROIs 312a-312b even if the corresponding license plate text detected is only in a portion of one or more of the encoding blocks 306aa-306mn. The number of the encoding blocks 306aa-306mn within each of the license plate ROIs 312a-312b may depend on the size of the license plates detected. In the example shown, the license plate ROI 312a may comprise six of the encoding blocks 306aa-306mn and the license plate ROI 312b may comprise two of the encoding blocks 306aa-306mn. The license plate ROIs 312a-312b may comprise several of the squares of the encoding blocks 306aa-306mn no smaller than the bounding box detected for the license plates 260a-260b. The bounding box for the license plate ROIs 312a-312b may be a rectangle for the vehicle license plate having a size of the pixel height and width of the license plate in the uncompressed video frames 202a-202n.

Dotted circles 320a-320d are shown at the corners of the license plate ROI 312a. The dotted circles 320a-320d may represent the corner pixels for the license plate ROI 312a. For example, the bounding box for the license plate 260a detected by the text location detection CNN 214 may be defined by the corner pixels 320a-320d. For example, a number of pixels from the corner pixel 320a to the corner pixel 320d may be a width of the bounding box for the license plate ROI 312a and a number of pixels from the corner pixel 320a to the corner pixel 320b may be a height of the bounding box for the license plate ROI 312a. For example, if each of the encoding blocks 306aa-306mn are 16×16 pixel blocks, the license plate ROI 312 a may be 48 pixels wide and 32 pixels high. While the corner pixels 320a-320d are only shown for the license plate ROI 312a as an illustrative example, corner pixels may similarly represent the size of the bounding box for the license plate ROI 312b and/or other license plates detected.

The text location detection CNN 214 may be configured to perform the license plate detection within the vehicle locations 310a-310b. For example, the license plate detection may be limited to within the vehicle locations 310a-310b and may not be performed outside of the vehicle locations 310a-310b. Limiting the license plate detection to the vehicle locations 310a-310b may provide efficient use computational resources (e.g., power consumption, processing cycles, etc.). For example, computational resources may not be wasted attempting to detect license plates where no license plate should be located. Limiting the license plate detection to the vehicle locations 310a-310b may further prevent false positives. For example, license plates that are not within a vehicle location may be a false positive (e.g., decorative license plates that may be hanging on a wall or the side of a building, discarded license plates, etc.). Limiting the operations performed by the text location detection CNN 214 to the vehicle locations 310a-310b may provide a smaller portion of the video frame compared to performing the operations on an entire video frame.

In some embodiments, the object detection CNN 212 and/or the text location detection CNN 214 may be configured to track the vehicle locations (e.g., the bounding boxes 270a-270c and/or the vehicle locations 310a-310b) for detected objects over time. In some embodiments, the object detection CNN 212 and/or the text location detection CNN 214 may be configured to determine the location of the bounding boxes 270a-270c and/or the license plate ROIs 312a-312b in each of the uncompressed video frames 202a-202n (or the downscaled video frames in the signal DVID). In some embodiments, the object detection CNN 212 and/or the text location detection CNN 214 may be configured to perform the vehicle detection at pre-determined intervals. In an example, the processor 102, the object detection CNN 212 and/or the text location detection CNN 214 may implement tracking to predict the locations of the vehicles 258a-258c and/or the license plates 260a-260c in between the detection intervals. For example, the tracking may be performed based on a distance, direction of travel and/or relative speed of the vehicles 258a-258c determined at the detection interval until the next detection interval. Predictive tracking of the location of the license plate ROIs 312a-312b in between regular detection intervals may save AI computation resources. In one example, the pre-defined detection intervals may be once for every particular amount of time (e.g., once every 10th of a second, every 20th of a second, every 30th of a second, etc.). In another example, the pre-defined detection intervals may be once for every particular number of video frames (e.g., once every other frame, once every third frame, once every five frames, etc.). In yet another example, the detection intervals may be adaptable based on an amount of movement of the ego vehicle 80 and/or a speed of traffic. Generally, the tracking may be performed as part of the vehicle detection performed by the object detection CNN 212 and/or the license plate detection performed by the text location detection CNN 214. For example, the object tracking may be an optimization for frames per second, and accuracy of the bounding box by using temporal domain information. The amount of time between detection intervals and/or the method of selecting a detection interval may be varied according to the design criteria of a particular implementation.

For every video frame (or detection interval), the text location detection CNN 214 may apply filtering to each of the license plate bounding boxes and/or the bounding boxes 270a-270c of the vehicles detected. The filtering may be configured to remove (or ignore) license plates that may be too far away from the ego vehicle 80 (or the image sensor 180) to provide legible text. For example, far-away license plates may comprise that may not even be readable in the uncompressed video frames 202a-202n. Encoding license plates that do not have legible text originally may not provide better clarity in the encoded video frames 204a-204n. In the example shown, the distance DC to the vehicle 258c may be too far to provide legible text and the text location detection CNN 214 may filter out the license plate 260c for generating the license plate ROIs. For each of the remaining license plate ROIs (e.g., the license plate ROIs 312a-312b in the example shown), the processor 102 may determine the adaptive QP offset value. For example, over time if the vehicle 258c moves closer to the image sensor 180, the license plate ROI may be determined for the license plate 260c. Similarly, over time if the vehicle 258a and/or the vehicle 258b moves farther away from the image sensor 180, the license plate ROIs 312a-312b may be filtered out. In one example, the distance may be a pre-determined distance value. For example, the pre-determined distance value may be determined in response to engineering experience and/or limitations of the image sensor 180. In some embodiments, the distance threshold may be reduced based on weather conditions (e.g., foggy weather may have reduced visibility). The particular distances for filtering out the license plates may depend on the resolution of the image sensor 180 and/or may be varied according to the design criteria of a particular implementation.

In some embodiments, the tracking performed by the text location detection CNN 214 may be configured to detect a relative speed of the vehicles 258a-258c. The text location detection CNN 214 may be configured to determine various parameters of the image sensor 180 (e.g., sensor gain level, exposure length, lens distortion, etc.). The combination of relative speed and/or the parameters of the image sensor 180 may be used to determine an amount of noise level in the video frame the and/or motion blur (e.g., a distortion level) of the vehicles in the uncompressed video frames 202a-202n. The amount of noise and/or motion blur may be used by the video encoding module 216 to determine the adaptive QP offset for each of the license plate ROIs 312a-312b.

The QP settings for the license plate ROIs 312a-312b may be adaptively selected. In one example, the QP settings may be selected based on the distances DA-DC (e.g., the size of the license plates). In another example, the QP settings may be selected based on the relative speed, motion blur and/or noise (e.g., distortion levels) determined for the license plate ROIs 312a-312b. In still another example, the QP settings may be determined based on a combination of distance and/or relative speed. The QP settings may be adaptively selected to provide legible text for each of the license plates 260a-260c (if possible). Each of the license plate ROIs 312a-312b may have different QP settings applied. The adaptive QP offset for each of the license plate ROIs may be selected to provide a balance of text clarity and overall video bitrate. For example, background details in the encoded video frames 204a-204n may be sacrificed (e.g., higher QP settings) to save bits to make vehicle license plate text more clear (e.g., lower QP settings).

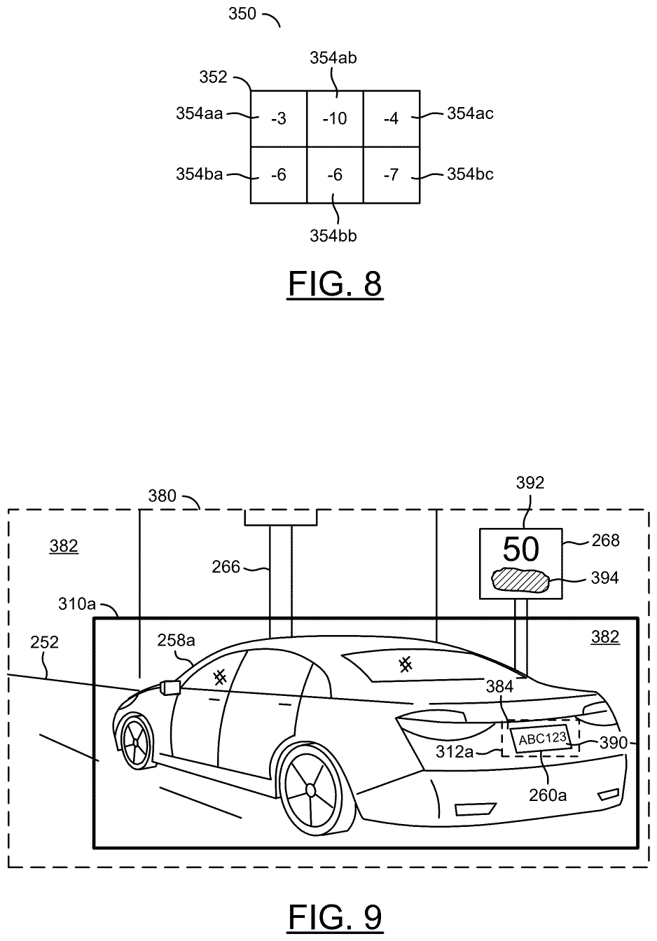

Referring to FIG. 8, a diagram illustrating an example encoding parameter offset to apply to a license plate region of interest is shown. An example adaptive encoding parameters offset 350 is shown. The example adaptive encoding parameters offset 350 may comprise an encoding region 352. In the example shown, the encoding region 352 may correspond to the license plate ROI 312a shown in association with FIG. 7. The video encoding module 216 may be configured to apply the adaptive encoding parameters offset 350 to the uncompressed video frames 202a-202n for the license plate ROIs 312a-312b to provide enhanced text clarity in the encoded video frames 204a-204n.

The encoding region 352 may comprise a number of offset parameters 354aa-354bc. The offset parameters 354aa-354bc may correspond to a subset of the encoding blocks 306aa-306mn shown in association with FIG. 7. The subset of the encoding blocks 306aa-306mn may correspond to the encoding blocks within the bounding box of one of the license plates for the license plates ROIs 312a-312b. In the example shown, the offset parameters 354aa-354bc may correspond to the encoding blocks 306aa-306mn of the license plate ROI 312a. For example, the license plate ROI 312a may comprise six of the encoding blocks 306aa-306mn, which may have six of the corresponding offset parameters 354aa-354bc. Different license plate ROIs may comprise a different number and/or location of the encoding blocks 306aa-306mn in the uncompressed video frames 202a-202n, resulting in a corresponding number of the offset parameters. The number of offset parameters adjusted for each of the detected license plates may be varied according to the design criteria of a particular implementation.

Encoding parameters may be selected by the video encoding module 216. The encoding parameters may be one type of parameter used to generate the encoded video frames 204a-204n. The encoding parameters adjusted by the video encoding module 216 may be adjustable on the fly (e.g., adjusted from frame-to-frame). In one example, the encoding parameters may apply to a Macroblock if the selected encoding protocol is H.264. In another example, the encoding parameters may apply to a CTB if the selected encoding protocol is H.265. The encoding parameters may be selected for the encoding blocks 306aa-306mn of the uncompressed video frames 202a-202n. There may be various encoding parameters that the video encoding module 216 may apply to the encoding blocks 306aa-306mn. In one example, the encoding parameters adjusted for the license plate ROIs 312a-312b may be QP. For example, the video encoding module 216 may select the offset parameters 354aa-354bc to adjust the QP (e.g., provide an offset from the general encoding parameters 226) from frame to frame for the encoding region 352 to apply the text clarity encoding parameters 228.

The video encoding module 216 may be configured to generate the encoded video frames 204a-204n at a pre-defined average bitrate. For example, the video encoding module 216 may be configured to apply the general encoding parameters 226 to the uncompressed video frames 202a-202n to generate a target average bitrate for the encoded video frames 204a-204n. The target average bitrate may be a bitrate achieved using the general encoding parameters 226 when no other adjustments are made (e.g., no text clarity is performed, no offset is determined, no license plates are detected, no road signs are detected, etc.). In one example, the target average bitrate may be selected by a person with appropriate expertise (e.g., an engineer). In another example, the target average bitrate may be a user selected input value. In yet another example, the target average bitrate may be constrained by the wireless communication device 156. In still another example, the target average bitrate may be limited to a communication bandwidth available. For example, the target average bitrate may change in real-time as communication conditions change. In an example, if the bandwidth available drops (e.g., due to interference, due to network traffic, due to hardware failures, etc.), the target average bitrate may temporarily adapt to a lower value. The selected target average bitrate may be varied according to the design criteria of a particular implementation.

The video encoding module 216 may be configured to perform QP reduction to provide the text clarity for the license plate ROIs 312a-312b. For example, when the license plate ROIs are detected, the video encoding module 216 may determine the encoding parameters offset 350. The encoding parameters offset 350 may provide an adjustment from the general encoding parameters 226. The encoding parameters offset 350 may reduce the value of the general encoding parameters 226 by the value of the offset parameters 354aa-354bc (e.g., provide a negative offset) to determine the text clarity encoding parameters 228. For example, the text clarity encoding parameters 228 may be determined by adjusting the general encoding parameters 226 downwards. In the example shown, the offset parameter 354aa may be a-3 value, the offset parameter 354ab may be a-10 value, the offset parameter 354ac may be a-4 value, the offset parameter 354ba may be a-6 value, the offset parameter 354bb may be a-6 value, the offset parameter 354bc may be a-7 value. In some embodiments, each of the offset parameters 354aa-354bc may have the same offset value. In some embodiments, each of the offset parameters 354aa-354bc may have the same or different offset values. The QP values may be adjusted to provide individual level tuning to provide beneficial results at a granular level. The offset parameters 354aa-354bc shown may provide example offset values for the QP reduction. Generally, smaller QP values (e.g., a greater absolute value of offset) may result in an encoding quality at the location of the encoding blocks 306aa-306mn having better (or clearer) details. The values of the offset parameters 354aa-354bc may be selected to provide a small QP value (but still greater than zero). For example, if the QP value is already very small, the negative offset applied may be a small number. The particular values of the offset parameters 354aa-354bc may be varied according to the design criteria of a particular implementation.

The offset parameters 354aa-354bc may be selected to provide the QP reduction such that the license plate ROIs 312a-312b are encoded with a video quality that provides legible text. The video encoding module 216 may further increase the QP for the general encoding parameters 226 outside of the license plate ROIs to compensate for a potential increase in average bitrate of the encoded video frames 204a-204n resulting from the negative offset of offset parameters 354aa-354bc applied to the license plate ROIs. For example, compensations may be made to achieve the same target average bitrate as when no license plates are detected.

The video encoding module 216 may be configured to provide the adaptive QP offset for encoding the uncompressed video frames 202a-202n to generate the encoded video frames 204a-204n. In some embodiments, other types of encoding may be implemented. In one example, the video encoding module 216 may be configured to perform a force-P-skip. The force-P-skip may use a previous value for the encoding blocks 306aa-306mn for the current video frame. The force-P-skip may reduce a bits cost by keeping the exact video data with previous video frames for the particular one of the encoding blocks 306aa-306mn. For example, in video sequences with a lot of cars, the AI adjusted region of interest encoding pipeline 200 may detect the car license plates only at particular frame intervals and perform license plate tracking with force-P-skip on the license plate ROIs in order to save bits and keep high video quality for the ROIs. The particular method of selecting the QP values for the encoding blocks in order to balance the video quality of license plate and total video bitrate may be varied according to the design criteria of a particular implementation.

Referring to FIG. 9, a diagram illustrating a portion of an encoded video frame with enhanced text clarity is shown. An encoded video frame portion 380 is shown. The encoded video frame portion 380 may provide an illustrative example of one of the encoded video frames 204a-204n. While the entire encoded video frames 204a-204n may be generated, the encoded video frame portion 380 shown may comprise less than a full encoded video frame for illustrative purposes. In some embodiments, the processor 102 may be configured to crop the encoded video frames 204a-204n to output less than the entire video content of the encoded video frames 204a-204n. In one example, the encoded video frame portion 380 may be a cropped window from a video encoded at a resolution and framerate of 1080p30, using H.265 encoding and having a target bitrate of 2 Mbps. The encoded video frame portion 380 may be encoded using both the general encoding parameters 226 (with or without a positive QP offset) and the text clarity encoding parameters 228 (e.g., derived from the general encoding parameters 226 based on the negative QP offset).

The encoded video frame portion 380 may comprise a portion of the video data from the example video frame 250 shown in association with FIG. 6. The encoded video frame portion 380 may be generated from the pre-processed video frames in the signal PVID. For example, the video encoding module 216 may be configured to map the locations of the license plate ROIs 312a-312b determined from the downscaled video frames in the signal DVID to the original size of the source images in the signal PVID. The encoded video frame portion 380 may comprise the roadway 252, the vehicle 258a with the license plate 260a, the advertisement sign 266, and the speed limit road sign 268. The vehicle location bounding box 310a is shown around the vehicle 258a and the license plate ROI 312a is shown around the license plate 260a. The vehicle location bounding box 310a and the license plate ROI 312a may be shown for illustrative purposes. Generally, the encoded video frames 204a-204n may be output without displaying indicators and/or visualizations for the bounding boxes (e.g., the bounding boxes may be output in a debug mode of operation).

An encoded region 382 is shown. The encoded region 382 may be encoded using the general encoding parameters 226. The general encoded region 382 may be a section of the encoded video frames 204a-204n that do not correspond with one of the license plate ROIs 312a-312b. In the example encoded video frame portion 380 shown, the general encoded region 382 may be the portion of the video frame outside of the vehicle location bounding box 310a. The general encoded region 382 may also be the portion of the video frame that may be within the vehicle location bounding box 310a but also outside of the license plate ROI 312a.

An encoded region 384 is shown. The encoded region 384 may be encoded using the text clarity encoding parameters 228. For example, the text clarity encoded region 384 may have QP values equal to the QP values of the general encoding parameters 226 but offset with the offset values 354aa-354bc. The text clarity encoded region 384 may be a section of the encoded video frames 204a-204n that does correspond with at least one of the license plate ROIs 312a-312b. In some embodiments, each of the license plates ROIs 312a-312b may be the text clarity encoded region 384 using the same QP values. In some embodiments, each of the license plate ROIs 312a-312b may be an encoded region with different text clarity encoding parameters 228 (e.g., different values for the adaptive encoding parameters offset 350 that may be less than the general encoding parameters 226).

License plate characters 390 are shown on the license plate 260a. The license plate characters 390 may be encoded using the text clarity encoding parameters 228. The text clarity encoded region 384 may be encoded such that the license plate characters 390 may be legible in the output encoded video frames 204a-204n. For example, the license plate characters 390 in the encoded video frames 204a-204n may have the same visual quality or slightly less visual quality than the text in the raw uncompressed video frames 202a-202n. The license plate characters 390 may be legible by a person directly viewing the encoded video frames 204a-204n. For example, the license plate characters 390 may be viewed and/or read directly, without relying on OCR provided in a separate data stream. By comparison, the text on the speed limit road sign 268 (e.g., part of the general encoded region 382) encoded using the general encoding parameters 226 may not be as clearly output in the encoded video frames 204a-204n as the license plate characters 390.

Sign text 392 and a blurry text 394 are shown on the speed limit road sign 268. The speed limit road sign 268 may be in the general encoded region 382. Since the general encoded region 382 may be encoded at a lower bitrate using the general encoding parameters 226, the text of the speed limit road sign 268 may suffer a loss in visual clarity in the encoded video frames portion 380. The amount of visual clarity of the text on the speed limit road sign 268 may depend on the value of the general encoding parameters 226, a size of the original text and/or a clarity of the original text in the uncompressed video frames. In the example shown, the sign text 392 may be large text of the number ‘50’. For example, the speed limit road sign 268 may provide a speed limit value in large text. The large text of the sign text 392 may be sufficiently large and/or clear in the uncompressed video frames 202a-202n to appear with clarity in the general encoded region 382 even when the lower bitrate from the general encoding parameters 226 are used.

The blurry text 394 may provide an illustrative example of the loss of quality for some of the text on the speed limit road sign 268. For example (as shown in association with FIG. 6), the speed limit road sign 268 may comprise the text ‘MPH’ at the location of the blurry text 394. Generally, road signs display the speed limit value in large text and the speed unit in smaller text. For example, the text size and/or clarity of the ‘MPH’ written on the speed limit road sign 268 may not be large enough and/or clear enough in the uncompressed video frames 202a-202n and the loss of quality introduced by the general encoding parameters 226 may result in the blurry text 394. In the example shown, the blurry text 394 may be illustrated as an irregular shape. In some embodiments, the blurry text 394 may appear blocky and/or pixelated in the encoded video frames 204a-204n. By comparison, while the general encoding parameters 226 may cause some text (e.g., the blurry text 394) to lose quality, the text clarity parameters 228 may ensure that the license plate characters 390 retain a sufficient amount of visual quality to remain visible.

In some embodiments, in order to maintain the target average bitrate in the encoded video frames 204a-204n, the QP values for the general encoded region 382 may be increased. For example, the general encoded region 382 may not be encoded with the general encoding parameters 226, but instead with the general encoding parameters 226 with a positive offset applied. Applying the positive offset in the general encoding region 382 may compensate for the lowering of the QP in text clarity encoding region 384. However, since the license plates may occupy a small area in the whole video frame, the QP increment of the general encoded region 382 for compensation may be very small (e.g., compared to the negative offset for the text clarity encoded region 384). For example, the effect of the QP increment for the general encoded region 382 on video clarity and/or subjective video quality may be almost imperceptible to human eyes.

The video encoding module 216 may be configured to determine the adaptive QP offset for each of the license plate ROIs 312a-312b. For example, each of the license plate ROIs 312a-312b may have unique negative offsets for the QP values. The video encoding module 216 may apply different text clarity encoding parameters 228 for each text clarity encoded region 384 (e.g., one for each of the license plates detected and within the pre-determined distance). The text clarity encoding parameters 228 may be further dependent upon other parameters detected (e.g., motion blur due to relative speed of the vehicles 258a-258c detected, gain level of the image sensor 180, exposure length of the image sensor 180, etc.). The QP offset for each of the text clarity encoding regions 384 may be determined independently to provide a balance of text clarity and overall video bitrate.

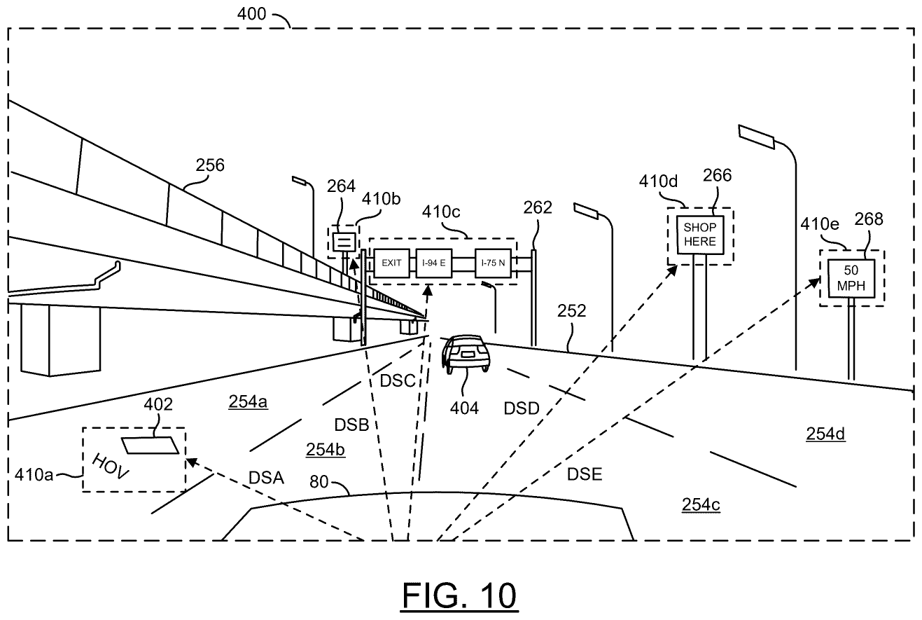

Referring to FIG. 10, a diagram illustrating computer vision operations performed on an example video frame to detect road sign locations is shown. An example video frame 400 is shown. The example video frame 400 may comprise one of the uncompressed video frames 202a-202n (or a pre-processed version of the uncompressed video frames 202a-202n provided in the signal PVID or a downscaled version of the uncompressed video frames 202a-202n provided in the signal DVID). The example video frame 400 may be similar to the example video frame 250 shown in association with FIG. 6. For example, the video frame 400 may represent one of the uncompressed video frames 202a-202n captured before or after the example video frame 250.

The example video frame 400 may comprise the ego vehicle 80, the roadway 252, the lanes 254a-254d, the overpass 256, the overhead directional road signs 262, the distant sign 264, the advertisement sign 266, and the speed limit road sign 268. In the example video frame 400, a painted road indicator 402 and a vehicle 404 are shown. The painted road indicator 402 may be a high occupancy vehicle (HOV) lane symbol. The vehicle 404 may be far away from the ego vehicle 80. Since the vehicle 404 is distant, the example video frame 400 may not comprise any license plates close enough to provide legible text.

In some embodiments, the object detection CNN 212 may not detect any vehicles within the pre-determined distance for text clarity and with no vehicle location bounding boxes, the text location detection CNN 214 may not provide any license plate ROIs. With no license plate ROIs, the video encoding module 216 may select the general encoding parameters 226 to encode the example video frame 400 at the target average bitrate.

In some embodiments, the AI adjusted region of interest encoding pipeline 200 may provide extended functionality to detect traffic signs to provide text clarity for traffic sign text in the encoded video frames 204a-204n, while maintaining the target average bitrate. The operations for providing text clarity for the road signs in the encoded video frames 204a-204n may be similar to the operations for providing the text clarity for the license plates. First, traffic sign location bounding boxes may be detected, then the text may be located based on the sign type detected to provide a road sign text ROI. With the road sign text ROIs determined, the negative offset to the encoding parameters may be applied to provide text clarity to the encoding blocks that correspond to the road sign text ROIs.

Dotted boxes 410a-410e are shown. The dotted boxes 410a-410e may comprise the sign location bounding boxes. The object detection CNN 212 may be configured to perform the object detection to detect the bounding box locations 410a-410e. In an example, the object detection CNN 212 may comprise the trained AI model 222 configured to determine various types of road signs. For example, the trained AI model 222 implemented by the object detection CNN 212 may be configured to detect useful signs but not necessarily perform text recognition (e.g., general OCR). For example, the object detection CNN 212 may be capable of ignoring and/or filtering out some types of text (e.g., text on buildings, people holding signs, graffiti, etc.). In one example, a useful sign may be a stop sign, a speed limit sign, a stop here sign, lane indicators, etc. Generally, useful signs may be common signs and/or signs on an enumerated set of signs to enable training data to be acquired. Arbitrary text may not be a useful sign. For example, arbitrary signs may not have a regular shape and/or color and/or may provide little consistency for training data. The types of road signs detected and/or ignored by the object detection CNN 212 may be varied according to the design criteria of a particular implementation.

Dashed arrows DSA-DSE are shown. The dashed arrows DSA-DSE may represent distance measurements performed by the object detection CNN 212. The distance measurements may determine a distance from the ego vehicle 80 (e.g., the location of the image sensor 180) and the sign location bounding boxes 410a-410e. Generally, the size of the bounding boxes for each of the signs may be different from each other based on the particular classification of road sign (e.g., overhead signs may be much larger than a stop sign, resulting in overhead signs having a larger bounding box size despite being farther away). For example, the object detection CNN 212 may compare the sign location bounding boxes 410a-410e to a particular class of road signs to compare signs to similar reference signs (e.g., compare a size of the speed limit sign 268 to other speed limit signs). The distances DSA-DSE may be used to filter out signs. Filtering out signs may ignore particular signs that may be too far away to provide legible text. For example, the filtering performed for the sign location bounding boxes 410a-410e may be similar to the distance filtering performed for the vehicle location bounding boxes 270a-270c.

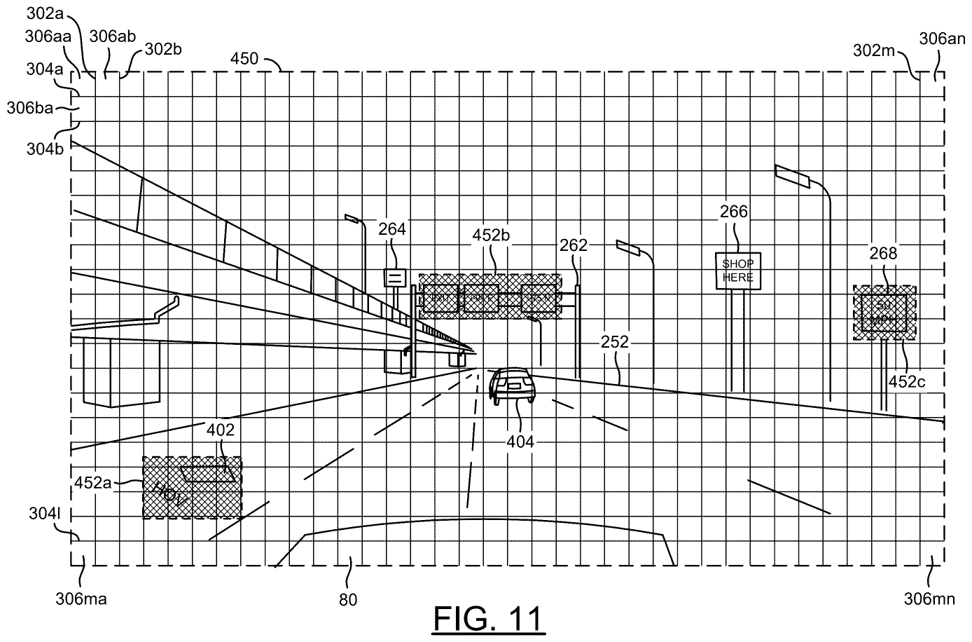

Referring to FIG. 11, a diagram illustrating sign text detection at a block level of a video frame is shown. An example sign text detection 450 is shown. The sign text detection 450 may comprise an illustrative example of the video frame 400 as described in association with FIG. 10. For example, the ego vehicle 80, the roadway 252, the overhead directional road signs 262, the distant sign 264, the advertisement sign 266, the speed limit road sign 268, the painted road indicator 402 and the vehicle 404 are shown. The sign text detection 450 may represent the determination of the ROIs performed by the text location detection CNN 214 in response to the signal VLOC and the uncompressed video frames 202a-202n. The sign text detection 450 may comprise the vertical lines 302a-302m and horizontal lines 304a-304l forming the grid pattern of the encoding blocks 306aa-306mn. For example, the encoding blocks 306aa-306mn may be similar to the encoding blocks 306aa-306mn described in association with FIG. 7.

Shaded regions 452a-452c are shown. The shaded regions 452a-452c may correspond to a location of the painted road indicator 402, the overhead directional road signs 262 and the speed limit road sign 268. The shaded regions 452a-452c may each represent a detected road sign text ROI. The road sign text ROIs 452a-452c may be detected by the text location detection CNN 214 in response to the signal VLOC. The signal TLOC may comprise the road sign text ROIs 452a-452c. While three of the road sign text ROIs 452a-452c are shown in the example road sign text detection 450, the number of road sign text ROIs detected may vary based on the number of road signs, types of signs and/or the distances to the road signs in the uncompressed video frames 202a-202n. The road sign text ROIs 452a-452c may comprise a total encoding block area (e.g., a macroblock/CTB area) for the road signs in order to provide text clarity in the encoded video frames 204a-204n.

In the example video frame 400 described in association with FIG. 10, the object detection CNN 212 may have detected five of the road sign location bounding boxes 410a-410e. For example, the text location detection CNN 214 may have received five candidates for the road sign text ROIs. In one example, the object detection CNN 212 may be configured to detect all text in the video frame as a possible candidate for text clarity and the text location detection CNN 214 may be configured to filter out the candidates based on size and/or sign type to provide clarity for known sign types. In some embodiments, the object detection CNN 212 may ignore text that comprises random/arbitrary text that may be difficult to classify.

The text location detection CNN 214 may perform filtering based on distance and/or sign type. In the example shown, the distance DSB to the sign location bounding box 410b may be too far away (e.g., the distant sign 264 may not have legible text). In the example shown, the advertisement sign 266 may comprise random/arbitrary text and the sign location bounding box 410d may be filtered out. In some embodiments, because of the classification of the sign as an advertisement the sign location bounding box 410b may be intentionally filtered out to remove annoyances and/or distractions in the encoded video frames 204a-204n (e.g., an ad blocking feature). After filtering out for distance and/or sign type, the road sign text ROIs 452a-452c may remain. The encoding blocks 306aa-306mn that correspond to the road sign text ROIs 452a-452c may be presented to the video encoding module 216.

The video encoding module 216 may be configured to determine the adaptive encoding parameters offset 350 for each of the road sign text ROIs 452a-452c. Similar, to the operations performed for the license plate ROIs 312a-312b, the video encoding module 216 may encode the road sign text ROIs 452a-452c using the text clarity encoding parameters 228 and the remaining portions of the example video frame 400 using the general encoding parameters 226 (or the general encoding parameters 226 with the positive offset for compensation). The text clarity encoding parameters 228 may enable the text within the road sign text ROIs 452a-452c to be clear and legible in the encoded video frames 204a-204n while providing the target average bitrate.

In the example shown in association with FIG. 7, only vehicle license plates are detected. In the example shown in association with FIG. 11, only road sign text is detected. However, the AI adjusted region of interest encoding pipeline 200 may be configured to detect both license plate ROIs and road sign ROIs in the same video frames. The AI adjusted region of interest encoding pipeline 200 may be configured to search for various text types, such as license plates and/or road traffic signs that have generally pre-defined shapes/colors. The AI adjusted region of interest encoding pipeline 200 may be configured to determine text clarity encoding parameters 228 to apply to the encoding blocks that correspond to the determined text locations so that text may be clear in the encoded video output. The AI adjusted region of interest encoding pipeline 200 may be implemented to efficiently perform detection operations so that high computational resources are not dedicated to perform the vision to detect the text locations. The ROIs may be detected efficiently so the encoding may be selected adaptively to provide clear text output.

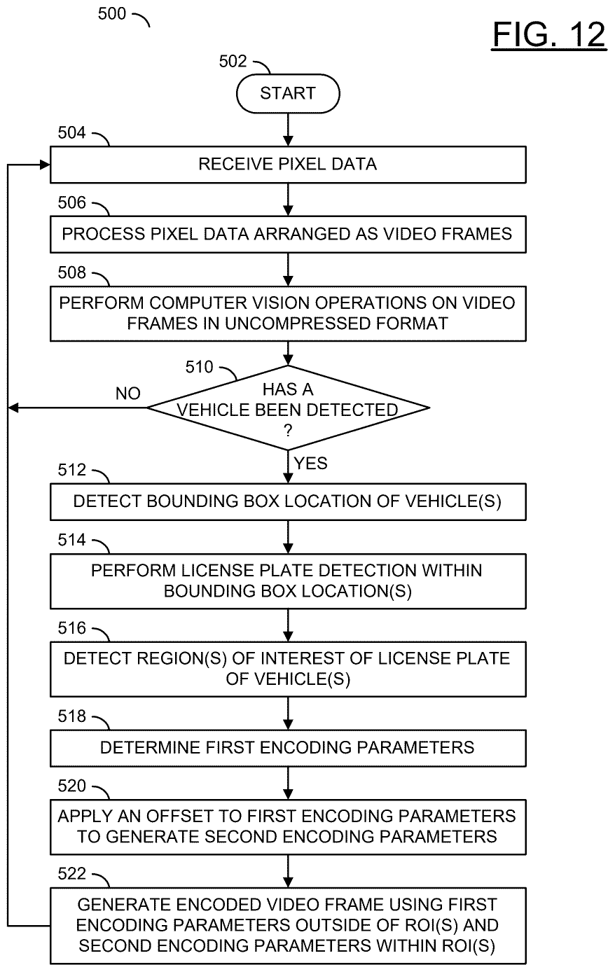

Referring to FIG. 12, a method (or process) 500 is shown. The method 500 may provide AI adjusted ROI encoding for improved license plate text clarity in recorded video. The method 500 generally comprises a step (or state) 502, a step (or state) 504, a step (or state) 506, a step (or state) 508, a decision step (or state) 510, a step (or state) 512, a step (or state) 514, a step (or state) 516, a step (or state) 518, a step (or state) 520, and a step (or state) 522.

The step 502 may start the method 500. In the step 504, the processor 102 may receive pixel data. For example, the image sensor 180 may generate the signal VIDEO comprising pixel data in response to the light input LIN captured by the capture device 104. Next, in the step 506, the processor 102 may process the pixel data arranged as video frames. For example, the processor 102 may perform various operations on the pixel data arranged as video frames (e.g., perform computer vision operations, calculate depth data, determine white balance, etc.). In one example, the video pre-processing pipeline 210 may perform video pre-processing operations on the input video frames 202a-202n to generate the signal PVID and/or downscaled video frames in the signal DVID (e.g., an uncompressed format). In the step 508, the processor 102 may perform computer vision operations on the video frames in an uncompressed format. For example, the object detection CNN 212 may detect vehicles (or signs) in the video frame in the uncompressed format. Next, the method 500 may move to the decision step 510.

In the decision step 510, the processor 102 may determine whether a vehicle has been detected. In some embodiments, the object detection CNN 212 may be configured to detect road signs in addition to vehicles. If no vehicle (or sign) has been detected, then the method 500 may return to the step 504. If a vehicle (or sign) has been detected, then the method 500 may move to the step 512. In the step 512, the processor 102 may detect the bounding box locations of one or more vehicles (and/or signs) detected. For example, the object detection CNN 212 may detect the bounding boxes 270a-270b and the signal VLOC may be generated. Next, in the step 514, the processor 102 may perform license plate detection within the bounding box locations. For example, the text location detection CNN 214 may search within the bounding boxes 270a-270b to detect the license plates 260a-260b. Similarly, text may be located within the bounding boxes 410a-410e for the road signs. In the step 516, the processor 102 may detect the region(s) of interest for the license plates of the vehicles. For example, the text location detection CNN 214 may determine the coordinates 320a-320d that correspond to the ROIs 312a-312b and generate the signal TLOC. Next, the method 500 may move to the step 518.

In the step 518, the processor 102 may determine the first encoding parameters. For example, the first encoding parameters may be the general encoding parameters 226. Next, in the step 520, the processor 102 may apply an offset to the first encoding parameters to generate the second encoding parameters. For example, the offset parameters 354aa-354bc may be applied to the general encoding parameters 226 to generate the text clarity parameters 228. In the step 522, the processor 102 may generate the encoded video frames 204a-204n using the first encoding parameters outside of the ROIs 312a-312b (e.g., the general encoding region 382) and the second encoding parameters inside the ROIs 312a-312b (e.g., the text clarity encoded region 384). For example, the video encoding module 216 may generate the signal TEVID comprising the encoded video frames 204a-204n. Next, the method 500 may return to the step 504.

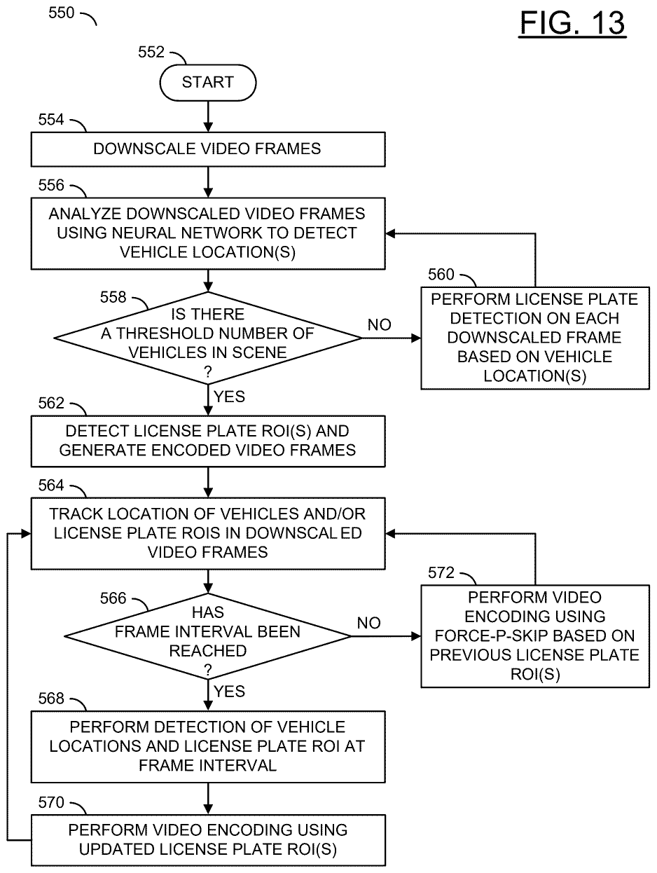

Referring to FIG. 13, a method (or process) 550 is shown. The method 550 may track object locations to enable ROI detection to be performed at frame intervals. The method 550 generally comprises a step (or state) 552, a step (or state) 554, a step (or state) 556, a decision step (or state) 558, a step (or state) 560, a step (or state) 562, a step (or state) 564, a decision step (or state) 566, a step (or state) 568, a step (or state) 570, and a step (or state) 572.

The step 552 may start the method 550. In the step 552, the downscaling module 220 may downscale the input video frames 202a-202n. For example, the video pre-processing pipeline 210 may generate the signal DVID in response to the signal VIDEO. Next, in the step 556, the object detection CNN 212 may analyze the downscaled video frames using the neural network model 222 to detect vehicle location(s). Next, the method 550 may move to the decision step 558.

In the decision step 558, the object detection CNN 212 may determine whether there is a threshold number of vehicles in the scene. For example, when there are many vehicles in the detected scene, performing detection at frame intervals may be efficient (e.g., a scene with many vehicles may have lots of slow moving vehicles that may not change location quickly over time). The number of vehicles for the threshold number may be varied (e.g., greater than 5). If there are not a threshold number of vehicles detected, then the method 550 may move to the step 560. In the step 560, the text location detection CNN 214 may perform the license plate detection on each of the downscaled video frames in the signal DVID based on the vehicle locations detected in each of the downscaled video frames (e.g., performed without object tracking). Next, the method 550 may return to the step 556. In the decision step 558, if there are a threshold number of vehicles detected, then the method 550 may move to the step 562.

In the step 562, the text location detection CNN 214 may detect the license plate ROIs 312a-312b and the video encoding module 216 may generate the encoded video frame 204i for the current input video frame. For example, the first detection may provide the baseline for tracking the objects over time. Next, in the step 564, the object detection CNN 212 and/or the text location detection CNN 214 may track the location of the objects (e.g., the vehicles and/or the license plate ROIs) in the downscaled video frames. Next, the method 550 may move to the decision step 566.

In the decision step 566, the object detection CNN 212 and/or the text location detection CNN 214 may determine whether the frame interval has been reached. The frame interval may be a pre-defined number of frames to wait before performing another detection of the vehicle location and/or the license plate ROI. If the frame interval has been reached, the method 550 may move to the step 568. In the step 568, the object detection CNN 212 and/or the text location detection CNN 214 may perform the detection of the vehicles and/or license plate ROIs at the frame interval. For example, updated locations for the vehicles and/or license plate ROIs may be detected at the frame intervals. Next, in the step 570, the video encoding module 216 may perform the video encoding based on the updated license plate ROIs 312a-312b. Next, the method 550 may return to the step 564.

In the decision step 564, if the frame interval has not been reached, then the method 550 may move to the step 572. In the step 572, the video encoding module 216 may perform the video encoding using force-P-skip based on the previous locations of the license plate ROIs. For example, force-P-skip may enable the macroblock/CTB results of the previous frame to be used for the current video frame. Next, the method 550 may return to the step 564.

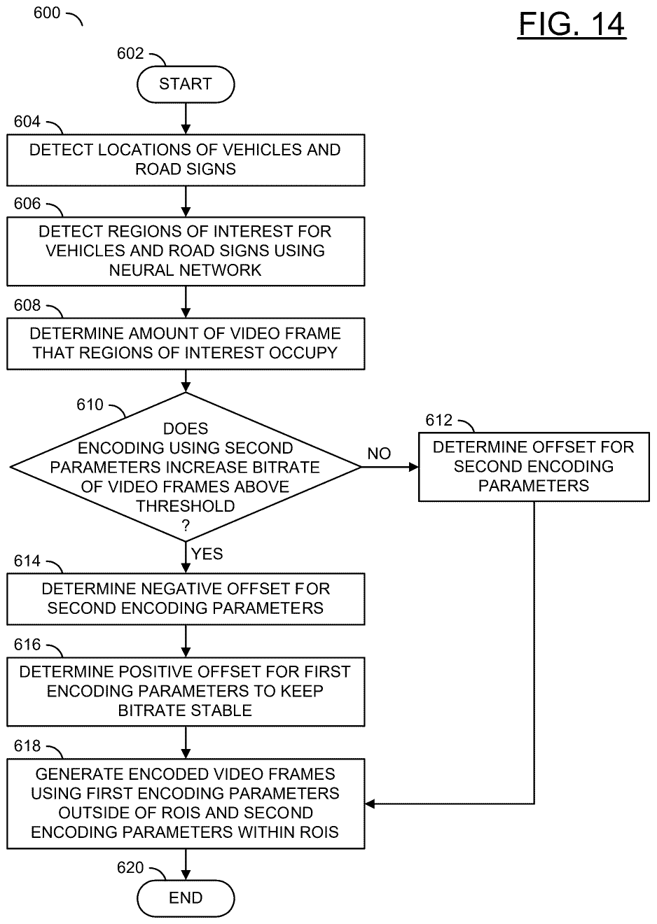

Referring to FIG. 14, a method (or process) 600 is shown. The method 600 may apply a positive offset to the general encoding parameters to provide a consistent bitrate. The method 600 generally comprises a step (or state) 602, a step (or state) 604, a step (or state) 606, a step (or state) 608, a decision step (or state) 610, a step (or state) 612, a step (or state) 614, a step (or state) 616, a step (or state) 618, and a step (or state) 620.

The step 602 may start the method 600. In the step 604, the object detection CNN 212 may detect the locations (e.g., bounding boxes) of the vehicles and/or road signs in the downscaled video frames. Next, in the step 606, the text location detection CNN 214 may use the neural network model 224 to detect the region of interest for the vehicles and/or road signs. In the step 608, the video encoding module 216 may determine the amount of the video frame that the regions of interest 312a-312b occupy. Next, the method 600 may move to the decision step 610.

In the decision step 610, the video encoding module 216 may determine whether the encoding using the text clarity parameters 228 may result in an increase in bitrate of the encoded video frames 204a-204n above a threshold value. For example, the threshold value may be an amount of available bandwidth to the wireless communication module 156. If the increase in bitrate caused by the text clarity parameters 228 being applied to the regions of interest 312a-312b, does not exceed the threshold, then the method 600 may move to the step 612. In the step 612, the video encoding module 216 may determine the negative offset from the general encoding parameters 226 to generate the text clarity encoding parameters 228. Next, the method 600 may move to the step 618. In the decision step 610, if the increase in bitrate caused by the text clarity parameters 228 being applied to the regions of interest 312a-312b does exceed the threshold, then the method 600 may move to the step 614.

In the step 614, the video encoding module 216 may determine the negative offset values 354aa-354bc for generating the text clarity encoding parameters 228. Next, in the step 616, the video encoding module 216 may determine a positive offset for the general encoding parameters 226. The positive offset may be determined to ensure that the bitrate of the encoded video frames 204a-204n remains stable (e.g., within the threshold of the available bandwidth). In the step 618, the video encoding module 216 may generate the encoded video frames 204a-204n using the general encoding parameters 226 (with the positive offset, if calculated) outside of the regions of interest and using the text clarity encoding parameters 228 within the regions of interest. Next, the method 600 may move to the step 620. The step 620 may end the method 600.

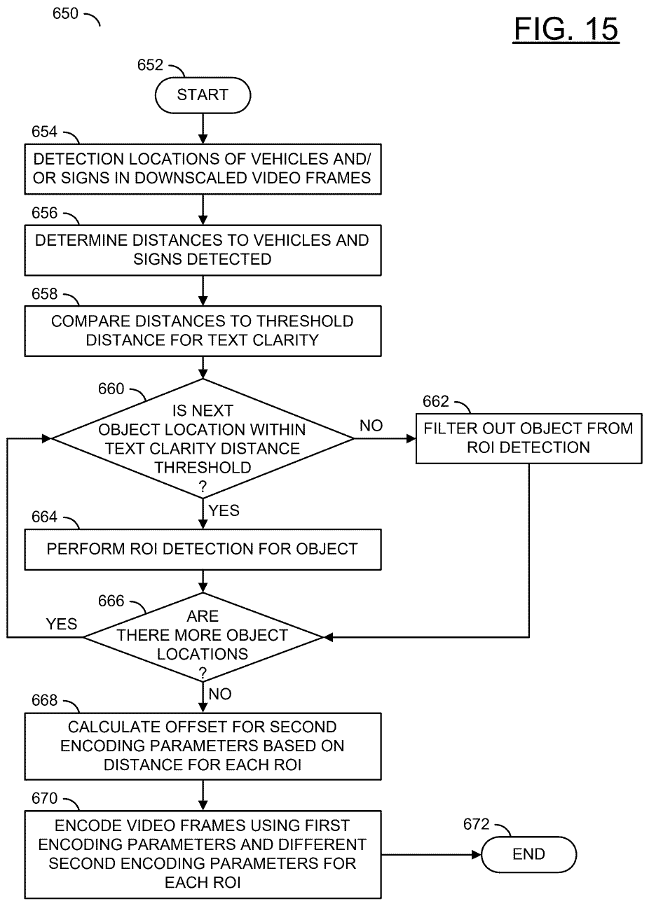

Referring to FIG. 15, a method (or process) 650 is shown. The method 650 may filter out license plate locations based on distance. The method 650 generally comprises a step (or state) 652, a step (or state) 654, a step (or state) 656, a step (or state) 658, a decision step (or state) 660, a step (or state) 662, a step (or state) 664, a decision step (or state) 666, a step (or state) 668, a step (or state) 670, and a step (or state) 672.

The step 652 may start the method 650. In the step 654, the object detection CNN 212 may perform the detection of the locations of vehicles and/or road signs in the downscaled video frames. Next, in the step 656, the object detection CNN 212 may determine the distances (e.g., DA-DC and/or DSA-DSE) to the detected vehicles and/or signs. In the step 658, the object detection CNN 212 may compare the distances to a threshold distance for text clarity. Next, the method 650 may move to the decision step 660.

In the decision step 660, the object detection CNN 212 may determine whether a next object location is within the text clarity distance threshold. If the next object is not within the text clarity distance threshold, then the method 650 may move to the step 662. In the step 662, the object detection CNN 212 may filter out the object from ROI detection (e.g., the object may be ignored). Next, the method 650 may move to the decision step 666. In the decision step 660, if the next object location is within the text clarity threshold, then the method 650 may move to the step 664. In the step 664, the text location detection CNN 214 may perform ROI detection of the object (e.g., determine the license plate ROI and/or the road sign ROI). Next, the method 650 may move to the decision step 666.

In the decision step 666, the object detection CNN 212 may determine whether there are more of the object locations detected. If there are more object locations detected, then the method 650 may return to the decision step 660. If there are no more of the object locations detected (e.g., all ROIs have been determined), then the method 650 may move to the step 668. In the step 668, the video encoding module 216 may calculate the negative offset parameters 354aa-354bc based on the distance for each of the remaining ROIs. For example, the ROIs that are at a greater distance may use a larger negative offset to compensate for a potential loss of clarity (e.g., smaller text at a distance may be more likely to be illegible after encoding than larger text, if the same encoding parameters are used). In an example, each of the ROIs may have a different negative offset value. Next, in the step 670, the video encoding module 216 may encode the uncompressed video frames in the signal PVID using the general encoding parameters 226 outside of the ROIs and using the different text clarity encoding parameters 228 for each of the different ROIs. Next, the method 650 may move to the step 672. The step 672 may end the method 650.

The functions performed by the diagrams of FIGS. 1-15 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. Execution of instructions contained in the computer product by the machine, may be executed on data stored on a storage medium and/or user input and/or in combination with a value generated using a random number generator implemented by the computer product. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROMs (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, cloud servers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

The designations of various components, modules and/or circuits as “a” “n”, when used herein, disclose either a singular component, module and/or circuit or a plurality of such components, modules and/or circuits, with the “n” designation applied to mean any particular integer number. Different components, modules and/or circuits that each have instances (or occurrences) with designations of “a” “n” may indicate that the different components, modules and/or circuits may have a matching number of instances or a different number of instances. The instance designated “a” may represent a first of a plurality of instances and the instance “n” may refer to a last of a plurality of instances, while not implying a particular number of instances.

While the invention has been particularly shown and described with reference to embodiments thereof, it will be understood by those skilled in the art that various changes in form and details may be made without departing from the scope of the invention.

1. An apparatus comprising:
an interface configured to receive pixel data; and
a processor configured to (i) process said pixel data arranged as video frames, (ii) perform computer vision operations on said video frames in an uncompressed format, (iii) detect a bounding box location for a vehicle in response to said computer vision operations, (iv) perform license plate detection within said bounding box location to detect a region of interest of a license plate of said vehicle, (v) determine first encoding parameters to generate encoded video frames from said video frames in said uncompressed format, (vi) determine second encoding parameters for said region of interest of said license plate and (vii) generate said encoded video frames using said first encoding parameters outside of said region of interest and said second encoding parameters within said region of interest, wherein
(a) an offset is applied to said first encoding parameters for said region of interest to determine said second encoding parameters, and
(b) said second encoding parameters provide clarity of text of said license plate within said region of interest while keeping an average bitrate of said encoded video the same as encoding an entire one of said video frames using said first encoding parameters.

2. The apparatus according to claim 1, wherein said processor is configured to implement (i) a first neural network configured to determine said bounding box location of said vehicle in said video frames, and (ii) a second neural network configured to detect said region of interest of said license plate of said vehicle within said bounding box location of said vehicle.

3. The apparatus according to claim 1, wherein said second encoding parameters enable said encoded video frames to provide said clarity of text of said license plate without increasing a file size.

4. The apparatus according to claim 1, wherein (i) said encoded video frames are communicated via a bandwidth-limited wireless communication and (ii) said average bitrate of said encoded video frames is restricted to a bandwidth of said bandwidth-limited wireless communication.

5. The apparatus according to claim 4, wherein encoding said video frames using said first encoding parameters without said second encoding parameters to achieve said bandwidth of said bandwidth-limited wireless communication results in a compressed video frame with unreadable text for said license plate.

6. The apparatus according to claim 1, wherein (i) said encoded video frames are generated without performing license plate text recognition and (ii) said clarity of text of said license plate enables a number of said license plate to be legible.

7. The apparatus according to claim 6, wherein said number of said license plate is not provided with said encoded video frames.

8. The apparatus according to claim 1, wherein said offset applied to said first encoding parameters comprises a negative value of a quantization parameter.

9. The apparatus according to claim 1, wherein (i) said uncompressed format of said video frames is a YUV format, (ii) a compression format for said encoded video frames is H.265 and (iii) said region of interest of said license plate comprises coding tree blocks.

10. The apparatus according to claim 1, wherein (i) said uncompressed format of said video frames is a YUV format, (ii) a compression format for said encoded video frames is H.264 and (iii) said region of interest of said license plate comprises macro blocks.

11. The apparatus according to claim 1, wherein said first encoding parameters and said second encoding parameters comprise block level video encoding parameters that are capable of being adjusted in real-time.

12. The apparatus according to claim 1, wherein (i) said region of interest comprises a total encoding block area corresponding to a location of said license plate in said video frames, (ii) said total encoding block area comprises a plurality of squares and (iii) said region of interest comprises a rectangular shape with a height in pixels and a width in pixels corresponding to said location of said license plate in said video frames.

13. The apparatus according to claim 1, wherein said bounding box location and said region of interest of said license plate are detected in each of said video frames.

14. The apparatus according to claim 1, wherein (i) said bounding box location and said region of interest of said license plate are detected in said video frames at pre-determined frame intervals and (ii) said processor is further configured to implement predictive tracking of said bounding box location and said region of interest of said license plate for a subset of said video frames captured in between said pre-determined frame intervals.

15. The apparatus according to claim 1, wherein (i) a positive offset is applied to said first encoding parameters to compensate for said offset applied to said second encoding parameters, (ii) said positive offset is selected to compensate for an increase in said average bitrate caused by said offset applied to said second encoding parameters and (iii) said positive offset to said first encoding parameters provides an imperceptible decrease in video quality to portions of said video frame outside of said region of interest of said license plate.

16. The apparatus according to claim 1, wherein when said offset to said second encoding parameters is selected to prioritize clarity of text on said license plate without regard for subjective video quality of said encoded video frames.

17. The apparatus according to claim 1, wherein (i) said video frames comprise a 1080p resolution and (ii) providing said offset for said second encoding parameters enables said clarity of text of said license plate without increasing a resolution of said video frames.

18. The apparatus according to claim 1, wherein said processor is further configured to (i) detect a road sign bounding box location in response to said computer vision operations, (ii) perform road sign text detection within said road sign bounding box location to detect a sign text region of interest of road sign text of a road sign, and (iii) use said second encoding parameters on said sign text region of interest to provide clarity of said road sign text.

19. The apparatus according to claim 1, wherein (a) said processor is further configured to (i) determine a distance to said vehicle based on a size of said bounding box location, (ii) compare said distance to said vehicle to a pre-determined distance and (iii) filter out said bounding box location from performing said license plate detection within said bounding box location if said distance is greater than said pre-determined distance and (b) said text of said license plate is illegible in said video frames beyond said pre-determined distance.

20. The apparatus according to claim 1, wherein (a) said processor is further configured to (i) determine a relative speed of said vehicle with respect to said apparatus, (ii) receive image sensor parameters used to capture said video frames, and (iii) determine a distortion level of said vehicle based on said relative speed and said image sensor parameters, and (b) said offset is further determined in response to said distortion level of said vehicle.
